(19) United States
(12) Patent Application Publication
(10) Pub. No.: US 2024/0184548 A1
(43) Pub. Date: Jun. 6, 2024

(54) DEAD ITERATION ELIMINATION

(71) Applicant: QUALCOMM Incorporated, San Diego, CA (US)

(72) Inventors: Cedric BASTOUL, Geispolsheim (FR); Maxime Joël SCHMITT, Strasbourg (FR); Benoit Jean Nicolas MEISTER, San Diego, CA (US); Chandan REDDY, Vandœuvre-lès-Nancy (FR)

(21) Appl. No.: 18/520,440

(22) Filed: Nov. 27, 2023

Related U.S. Application Data
(60) Provisional application No. 63/429,888, filed on Dec. 2, 2022.

(51) Int. Cl. G06F 8/41

(52) U.S. Cl. CPC G06F 8/41

(57) ABSTRACT

A processor-implemented method includes receiving input program code. The method also includes generating a polyhedral representation of the input program code to obtain an iteration space and a data space. The method further includes identifying dead iterations within the iteration space based on the data space and a specified output data space. The dead iterations comprise iterations not contributing to the specified output data space. The method also includes generating, based on the input program code, output program code without the dead iterations.

### CROSS-REFERENCE TO RELATED APPLICATION

The present application claims the benefit of U.S. Provisional Patent Application No. 63/429,888, filed on Dec. 2, 2022, and titled “DEAD ITERATION ELIMINATION,” the disclosure of which is expressly incorporated by reference in its entirety.

### FIELD OF THE DISCLOSURE

The present disclosure generally relates to compilation of computer code, and more specifically to eliminating computer code corresponding to dead iterations during execution of the computer code.

### BACKGROUND

Dead code in a computer program corresponds to program parts that are not contributing to the program output. The dead code is either code that is not executed or code that produces data that is not used. The removal of dead code may increase the program performance and reduce the executable size.

Existing techniques focus on fully removing dead instructions or complete loops from the program code. However, some dynamic executions of the instructions may be dead. This situation may occur when an instruction is enclosed inside a loop, and a subset of the iterations of the loop do not contribute to the program output. It would be desirable to have a technique that identifies and removes those iterations.

### SUMMARY

In aspects of the present disclosure, a processor-implemented method includes receiving input program code. The method also includes generating a polyhedral representation of the input program code to obtain an iteration space and a data space. The method further includes identifying dead iterations within the iteration space based on the data space and a specified output data space. The dead iterations comprise iterations not contributing to the specified output data space. The method also includes generating, based on the input program code, output program code without the dead iterations.

Other aspects of the present disclosure are directed to an apparatus. The apparatus has one or more memories and one or more processors coupled to the one or more memories. The processor(s) is configured to receive input program code. The processor(s) is also configured to generate a polyhedral representation of the input program code to obtain an iteration space and a data space. The processor(s) is further configured to identify dead iterations within the iteration space based on the data space and a specified output data space. The dead iterations comprise iterations not contributing to the specified output data space. The processor(s) is also configured to generate, based on the input program code, output program code without the dead iterations.

Other aspects of the present disclosure are directed to an apparatus. The apparatus includes means for receiving input program code. The apparatus also includes means for generating a polyhedral representation of the input program code to obtain an iteration space and a data space. The apparatus further includes means for identifying dead iterations within the iteration space based on the data space and a specified output data space. The dead iterations comprise iterations not contributing to the specified output data space. The apparatus also includes means for generating, based on the input program code, output program code without the dead iterations.

In other aspects of the present disclosure, a non-transitory computer-readable medium with program code recorded thereon is disclosed. The program code is executed by a processor and includes program code to receive input program code. The program code also includes program code to generate a polyhedral representation of the input program code to obtain an iteration space and a data space. The program code further includes program code to identify dead iterations within the iteration space based on the data space and a specified output data space. The dead iterations comprise iterations not contributing to the specified output data space. The program code also includes program code to generate, based on the input program code, output program code without the dead iterations.

Various embodiments discussed below evaluate a given source code and identify a portion thereof, e.g., a loop nest, the execution of which may depend on one or more variables (also called parameters), where the values of one or more of the parameters may become known only at runtime, and are not known statically, at compile time. The source code or its identified portion is transformed into an internal representation (IR) (e.g., a GDG) used in polyhedral compilation. Thereafter, different versions of the IR are generated, each having a different context. A context can represent the constraints to be enforced during subsequent polyhedral compilation. These constraints may direct the polyhedral compiler to perform various tradeoffs such as parallelization vs. maximization of data locality; data-layout transformation (e.g., to improve cache performance) vs. parallelization; data locality optimization vs. utilization of available processors, etc.

Because the different versions of the IR have different contexts or constraints, the subsequent polyhedral compilation of each version can explore a different tradeoff. For example, one version may favor sequential execution while the other may favor a parallelized execution. Alternatively, two versions may both parallelize the code to be executed but the distribution of the operations allocated to different processors may be different. One version may employ loop tiling, e.g., to improve cache performance while the other may not. Different combinations of such optimizations may also be explored across different versions.

In order for the subsequent polyhedral compilation to explore a wide range of tradeoffs, the respective constraints that are provided to each version are designed to be non-overlapping or distinct. These constraints are based on the expected values the different parameters may take on at runtime.

Accordingly, in one aspect, a method is provided for compiling source code that may facilitate tradeoffs between parallelization, data-locality, and/or data-layout transformation, by versioning source code at compile time. The method includes performing by a processor the step of receiving and transforming source code that includes one or more run-time-determinable parameters into a base internal representation (IR) of a polyhedral compiler. The method also includes creating several dedicated versions of the base IR, where each dedicated version includes a respective context. Each respective context may represent a distinct respective combination of potential values of the parameters. Additionally, the method includes generating a respective source code version corresponding to each dedicated version of the base IR. and deriving a wrapper function for conditionally invoking the respective source code versions.

The source code may include a loop nest. A particular one of the one or more run-time-determinable parameters can be a bound of a loop in the loop nest or a memory access variable specified in the loop in the loop nest. The base IR may include a generalized dependence graph (GDG). In some embodiments, creating the several dedicated versions of the base IR includes creating a tree of several different GDGs.

In some embodiments, for a particular dedicated version of the base IR, a corresponding context representing a corresponding combination of the potential values of the parameters may include one or more constraint functions. A constraint function may be specified in terms of the potential values of one or more of the parameters. In some embodiments, the method may further include linearizing the constraint function via affine approximation. Alternatively or in addition, the method may further include linearizing the constraint function using an artificial neural network trained for polyhedral smoothing.

To conditionally invoke a particular source code version, the wrapper function may be configured for evaluating at runtime the combination of potential values of the parameters. The combination of the potential values of the parameters may be represented as a solution to a set of affine functions. Evaluating the combination of potential values of the parameters at runtime may include evaluating each affine function in the set at most once.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 depicts a procedure for providing information to a mapper in a polyhedral compiler to perform versioning, according to one embodiment.

FIG. 2 depicts a procedure for generating a tree of structures of source code (the structures may be called generalized dependence graphs (GDGs)), different structures corresponding to different generated versions of the source code, according to one embodiment.

FIG. 3 depicts a procedure for phase one of linearization of non-linear constraints to be provided to a polyhedral compiler to perform versioning, according to one embodiment.

FIG. 4 depicts a procedure for phase two of linearization of non-linear constraints to be provided to a polyhedral compiler to perform versioning, according to one embodiment.

FIG. 5 schematically depicts an exemplary linearization of constraints.

FIG. 6 schematically depicts smoothing of non-linear constraints by training an artificial neural network, according to one embodiment.

FIG. 7 is a block diagram illustrating an example implementation of a host system-on-a-chip (SoC) for performing dead iteration elimination, in accordance with various aspects of the present disclosure.

FIG. 8 is a diagram illustrating an example of dead code removal.

FIG. 9 is a diagram illustrating an example of dead iteration removal, in accordance with various aspects of the present disclosure.

FIG. 10A is a block diagram illustrating an example of a high level subgraph, in accordance with various aspects of the present disclosure.

FIG. 10B is a diagram illustrating an example of fused operator code corresponding to the composition of operators shown in FIG. 10, in accordance with various aspects of the present disclosure.

FIG. 10C is a diagram illustrating an example of fused operator code after dead iteration elimination, in accordance with various aspects of the present disclosure.

FIG. 11 is a flow diagram illustrating an example of dead iteration elimination, in accordance with various aspects of the present disclosure.

FIG. 12 illustrates an example of pseudocode for a dead iteration space analysis process, in accordance with various aspects of the present disclosure.

FIGS. 13 and 14 illustrate an example of sparsification/subsampling, in accordance with various aspects of the present disclosure.

FIGS. 15A and 15B illustrate examples of a compiler warning, in accordance with various aspects of the present disclosure.

FIG. 16 illustrates an example of code for a polyhedral model application, in accordance with various aspects of the present disclosure.

FIG. 17 illustrates an example of a polyhedral representation corresponding to the code illustrated in FIG. 16, in accordance with various aspects of the present disclosure.

FIG. 18 illustrates an example of a data dependence graph and an inverted data dependence graph, in accordance with various aspects of the present disclosure.

FIG. 19 is flow diagram illustrating an example of a process for removing dead iterations, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Various aspects of present disclosure are directed to compilation of computer programs and more specifically to eliminating dead code corresponding to dead iterations in a computer program. Dead code corresponds to program parts that are not contributing to the program output. The removal of dead code may increase the program performance and reduce a size of an executable. In contrast to existing techniques that focus on fully removing dead instructions or complete loops from the code, aspects of the present disclosure aim at removing finer grain dead instruction executions. Instruction executions refer to the various runtime executions of the same instruction that occur when that instruction is enclosed inside a loop. The techniques of the present disclosure enable the analysis of instruction executions not contributing to the program output and removal of the non-contributing instructions.

Aspects of the present disclosure exploit an algebraic representation of program code, known as the polyhedral model. The polyhedral model representation offers fine-grain iteration-level abstraction of the instructions and memory-cell-level abstraction of the variable/array/tensor accesses. The techniques of the present disclosure alter the polyhedral representation and have six main stages. First, a polyhedral representation of the input program code is obtained. Also, function live-out data information, e.g., a specification of the desired output data space from either code analysis or user input, is obtained. Second, a data-dependence graph of the input program code is built from the polyhedral representation. Third, an inverted data-dependence graph is built to model the node traversal ordering. Fourth, statements associated with dead iterations not contributing to the output are analyzed, through propagation of data space constraints along an inverted data-dependence graph and operations on the data space. Fifth, each statement iteration space is restricted to a portion of the iteration space that contributes to the output by modifying its polyhedral representation. Lastly, final code is generated based on its polyhedral representation altered by the previous step. Also, dead iteration space information is output.

Techniques of the present disclosure achieve finer-grain optimization due to dead code elimination (DCE) performed at a statement iteration level rather than at a full statement level. The techniques enable new applications when a specification of the output data space exists. The techniques enable composition of high-level computational operators (e.g., artificial intelligence/deep learning (AI/DL) operators) with automatic removal of non-pertinent computation, reducing the need for specialized custom operators, and code specialization or sparsification. The techniques remove full statements in situations that could not be identified by existing dead code analysis, in a complementary way. The techniques also provide static analysis by exposing potential programming bugs during software development (e.g., ill-formed loops, out-of-bound array accesses, etc.).

Details about polyhedral representation are now discussed.

### 1 Introduction

Polyhedral compilers can realize powerful optimizations and parallelization of loop-based programs by deriving a polyhedral representation of the loop code, performing intricate mathematical operation on that representation, and then rendering the transformed polyhedral representation as code. The final code can be rendered in a parallel programming language (e.g., C with OpenMP or pthreads, CUDA) or in a compiler's internal representation, from which scalar, single-thread optimization is performed.

Modern compilers are able to leverage optimization opportunities arising under specific run-time conditions by generating a variety of optimized code variants, and informing the runtime of when to use each variant. This process is called versioning (or sometimes multi-versioning). A typical example is when alias analysis is unable to statically disambiguate two pointers.

The compiler may detect that if said pointers were not aliased, more instructions could be run in parallel. If this is the case, the compiler may insert code that performs a run-time non-aliasing test, uses the optimized code when the test holds, and uses the unoptimized code otherwise.

While versioning has been used by compilers, including in the polyhedral raising phase, to the best of our knowledge, techniques to employ versioning in the mapping phase, where versioning can achieve significant tradeoffs between parallelization, data-locality maximization, and/or data layout transformation, have not been explored. Polyhedral mapping is the process of reordering operations and data in a loop-based computation to produce an optimized sequence and mapping said computation, targeting a particular computer hardware platform. We describe an implementation of versioning in the R-Stream™ polyhedral compiler (also known as a polyhedral mapper) and discuss how we enabled the processor placement pass to use it. Here, mapping or processor placement generally refers to assigning operations of different processing units for execution thereof. The techniques described herein are not limited to R-Stream, and can be implemented in any polyhedral compiler. R-Stream may also be referred to as a Polyhedral Mapper.

### 1.1 Application Domain

The need for versioning appeared important to us while mapping deep learning codes. Tensor sizes are dynamic in some neural networks (as for instance where a variable number of objects can be detected), and it seems worthwhile to adapt the polyhedral optimization strategy for layers that access these tensors as a function of the run-time tensor sizes. Hence, while versioning may be useful in other application domains, we use deep learning layers to illustrate the utility of versioning in a polyhedral compiler.

### 1.2 Model of an Optimized Code Region

To simplify the discussion, we assume, without loss of generality, that the loop code region modeled by a polyhedral representation is outlined into a function. This way, we can refer to the optimized code region as a function and its live-in and live-out values as the function's formal parameters. By the same token, we are looking at applying versioning to the values of the function's formal parameters.

After outlining is done, we consider programs with at least one function with parameters (also called arguments) (e.g., a pointer, an integer, or a floating-point number) that satisfy either of the following conditions:

At least one argument of the function is defined by a run-time value.

The function is called with varied values for at least one argument.

We note that recursive functions, which can be generated from polyhedral programs, almost always satisfy both conditions. However, in our experiments we choose to focus on deep learning layers, which are, in our experience, rendered as non-recursive.

### 1.3 Versioning Approach

Typically, versioning occurs in (at least) one of three places:

Prior to compilation, the user can incorporate knowledge about the run-time values of the function arguments into the program logic for consideration by the polyhedral compiler. In R-Stream, this is explicitly supported for users through a special pragma annotation.

Just-in-time (JIT) compilation creates versions of code regions, in which the function arguments are fixed to frequently-used values. However, the type of versioning performed at run-time compilation is limited by the need to minimize compilation time. Hence, versions would be determined by the run-time values of the function arguments. Furthermore, polyhedral compilation is generally considered too slow to be used in a JIT context.

In ahead-of-time compilation, the compiler generates code for a function with numerical arguments that conditionally executes optimized and parallelized code upon checking the run-time argument values.

### 1.4 Overview

In the discussion below, we provide an ahead-of-time approach to versioning programs or source code in the polyhedral model. In our approach, we attempt to make minimal assumptions about the implementation and design details of the underlying polyhedral compiler infrastructure. Hence, we anticipate that any polyhedral compiler can be reasonably extended to support our approach to versioning. Having successfully implemented our versioning approach in R-Stream, we describe the salient issues and suggest how to address these in the relevant sections.

We first provide an overview of polyhedrals in the context of polyhedral compilation, to understand the rest of the discussion, in Section 2. The motivation for versioning is discussed in Section 3. Then, we detail our approach to polyhedral versioning in Section 4. Section 5 describes linearization of non-linear constraints derived from the parameters, the values of which may not be known at compile time, and would be known only at runtime. We validate the need for versioning experimentally and its impact on compilation time in Section 6, using a few examples of the source code for deep learning, as the code to be compiled and optimized for execution.

### 2 Overview of Polyhedra in Polyhedral Compilation

This section offers an overview of the main concepts needed to understand the technical description of the polyhedral versioning approach presented here.

### 2.1 Polyhedra

In a vector space V, a polyhedron P⊆V is the set of solutions to a set of linear inequalities:

P: Ax+b≥0, x∈V (2.1)

Geometrically, Equation (2.1) defines P as the intersection of finitely many half-spaces in V given by the rows of A. A finite polyhedron is called a polytope.

It is possible to consider a subset of the dimensions of V as special variables, which do not get instantiated. Such variables are called the parameters of the polyhedron. For example, let us consider a parametric polytope example below, which has two variables (i, j) and two parameters (n, m):

Q(i,j)={(i,j)∈ [symbol] ²: 0≤i≤n; 0≤j≤m} (2.2)

Q is the set of lattice points of the rectangle whose lower left and top right corners are at (0,0) and (n, m), respectively. As hinted in Equation (2.2), in the polyhedral model of loops, we are often interested in integer-valued points inside the polyhedral.

### 2.2 Automatic Optimization Flow

In the polyhedral model of compilation, typically there are three main phases: raising, mapping, and lowering. The raising phase translates the program from the input form to a polyhedral intermediate representation (IR). Typically, the program source code is transformed into a base IR. The mapping phase performs the optimizations and parallelizations, termed mapping decisions, on the base polyhedral IR of the program. The part of the polyhedral compiler that performs the mapping phase is termed the (polyhedral) mapper. Finally, the lowering phase translates the mapped program from the polyhedral IR to the output language, e.g., C, C++, etc. Thus, a typical polyhedral compiler is a source-code to source-code compiler that transforms the originally specified source code into a modified source code that is optimized for one or more of parallelized execution, data locality, cache performance via data layout transformation(s), etc. The modified source code may be compiled using a traditional compiler to obtain an executable.

### 2.3 Polyhedral IR

The base polyhedral IR represents an approximation of the input code that uses affine expressions and leads to safe dependencies. The polyhedral IR, such as that used by R-Stream, may be based on Generalized Dependence Graph (GDG).

The polyhedral model focuses on the optimization of nested loop code that typically operate on multi-dimensional arrays. Hence, loop iteration domains and array access functions are first-class elements of polyhedral representations. A loop nest generally includes several loops that are partially or entirely nested within one or more outer loops. A single loop may also be referred to as a loop nest. GDG vertices represent polyhedral statements, which define an iteration domain, an operation performed for each iteration of the iteration domain, and a set of functions used to access data usually represented as multi-dimensional arrays, though one-dimensional arrays may also be accessed in some cases. GDG edges represent pairwise dependence relationships between polyhedral statements (vertices). We distinguish two types of polyhedral statements here:

ClientOps represent operations in the input function, associated with their polyhedral iteration domain and the array access functions involved in said operations. The semantics of a function raised into a GDG are fully captured by a set of ClientOps.

PseudoOps are operations introduced by the mapper to express a parallel mapping of code. Examples include direct memory access (DMA) transfers, barriers, thread spawning, asynchronous scheduling of a task, function calls and others.

Each raised function in the input IR is initially represented in the polyhedral IR as one GDG. The mapping process transforms the GDG, often with relation to a hierarchy of GDGs, where each GDG is analogous to a function. The GDG hierarchy can take the form of a general graph (since recursive calls form cycles), but there is always a root GDG, without predecessors, for each input function. Calling the input function is equivalent to calling the root GDG.

Since the GDG hierarchy shape is largely that of a tree, we refer to the source of an edge in the GDG hierarchy as a parent GDG. The destination of an edge in the GDG hierarchy is called a sub-GDG. The function arguments (if any) of an input function become the GDG parameters. The iteration domain and array access functions of polyhedral statements may be functions of the GDG parameters. Each GDG defines a polyhedral domain of the GDG parameter values for which the GDG is “valid.” This validity domain can represent preconditions to the function or simply the set of values for which the polyhedral statements' iteration domains are not all empty. We refer to a GDG's validity domain as the GDG's context throughout the discussion below.

As an example, consider the loop nest below:

for €=1 to m

for j=1 to n

X[i+k][j+l]=A[i][j]*B[i−k][j]

In this example, which is illustrative only and not limiting, the variables m and n define loop bounds which, in turn, determine the trip count for the loop operations. The variable k and I determines data access (also referred to as array access). Suppose the value of I can be determined at compile time, but the values of m, n, and k can be determined only at runtime. In that case, m, n, and k are parameters.

Expressions such as m, n, (m+2n+5) (though the last one is not used in the example code above) are examples of affine functions. m<32, m<1000, n≥100 are examples of affine constraints. The constraints themselves can be Boolean-valued functions. The context specified for an IR (e.g., a GDG) is the set of parameter values for which all the constraints of the context are true. In particular, a context for a GDG may be specified as the constraints m<32 and n≥100. The compilation of that GDG would then explore optimizations under the assumption that the values of the parameters m and n satisfy the specified constraints. Another version of the GDG may be created, but with a different constraint m<1000. Here, the compilation of this version of the GDG would explore potentially different optimizations under the assumption that the values of the parameter m satisfies the different specified constraint.

### 3 Motivation

TensorFlow is one of the leading Deep Learning research frameworks. Users can use it to compose Deep Learning models, train them, and finally deploy them for inferencing. As part of an effort to optimize inferencing by these models, we built the very first polyhedral deep learning optimizer by creating a TensorFlow front-end to R-Stream. This exposed us to models that repeat the use of some layers with varying input tensor sizes (e.g., a family of residual neural nets). In some cases, these sizes are fixed and known at the compile time, which allows the mapper in R-Stream (a polyhedral compiler, in general) to know everything about the iteration domains and access functions of the polyhedral statements representing the layers at compile time. We observed that R-Stream's polyhedral mapper made different mapping decisions for different input sizes.

However, another set of neural networks use and produce tensors whose sizes are only known dynamically, e.g., an object-detection net that may be used for autonomous driving, where the detection networks may detect a variable set of objects, depending upon the input image. In these cases, some of the tensor sizes will be unknown at compilation time, and they have to be treated as parameters in the polyhedral IR.

Still, we want the mapping decisions to internalize the tensor sizes, even though the mapper may not know much about the particular run-time tensor sizes. The next section presents our approach to solving this problem using versioning.

### 4 Approach

A € approach would be to enumerate all possible values of the parameters and optimize the code for each of them. Without prior knowledge about the run-time values, this is not efficient let alone practical, since this approach could generate unreasonably large amounts of code or a GDG's context can be unbounded.

Instead, we divide the space of all collections of parameter values into finitely many ranges. Then we let the mapper generate mapping decisions for each range. Because the context of a GDG is defined to be a polyhedron, we restrict our focus to ranges that are polyhedral domains. Our approach to versioning can be realized as the answers to the following questions:

How to inform the mapper to incorporate a given context sub-domain into its mapping process? (Section 4.1)

How to auto-generate the useful context sub-domains? (Section 4.2)

How to generate the subsequent versioned code? (Section 4.3)

The answers to these questions are detailed below.

### 4.1 Informing the Mapper

In this section, we define the way in which a mapper is informed to version its mapping decisions for a GDG (an IR, in general) towards a given set of affine constraints over its parameter values.

We define the following notions that are used for informing the mapper: specializing a GDG, specialized GDG, family of specialized GDGs, SpecializeOp and dedicated GDG. In our approach, when the mapper is provided a GDG and an extra set of affine constraints over its parameter values to consider, the mapper clones the GDG and adds the constraints to the clone GDG's context, which will be used to make mapping decisions. Since this particular way of versioning forms a subset of the original context, we refer to this cloned GDG as a specialized GDG and the process itself as specializing a GDG. Specializing a specialized GDG is possible and well-defined. A family F of specialized GDGs is a maximal set of GDGs where either of the following conditions exclusively holds for G′∈F:g:

∃G∈F, G≠G′, G′ is a specialized GDG generated by specializing G

G′ is the unique GDG in F which is not a specialized GDG, or equivalently, the first specialization in the family started by specializing G′

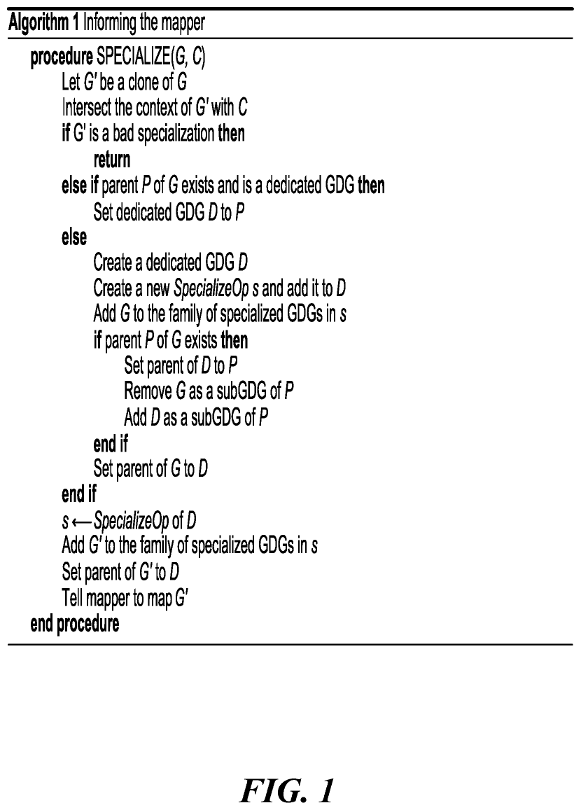

A SpecializeOp is a PseudoOp whose sole purpose is to maintain the set of GDGs in a family of specialized GDGs. A dedicated GDG (a dedicated version of the base IR, in general) is a GDG that is created by the mapper and contains exactly one SpecializeOp; together these form the mapper state that keeps track of the versioning. A dedicated GDG will be the parent GDG (in the GDG hierarchy) of all the GDGs in the family of specialized GDGs, which is given by the SpecializeOp contained in the dedicated GDG. Having defined these notions, we provide the Specialize procedure (FIG. 1) that precisely gives our approach. Specialize takes as input a GDG G and a set of affine constraints C.

A specialized GDG is a bad specialization if its context is empty or if there already exists a version of this GDG with the same context. Mapping an extra GDG G′ requires extra work from the mapper, in terms of processor cycles and time, memory usage, and energy consumption. Since the requirement of these resources, especially polyhedral mapping time, can be non-trivial, an important trade-off between compilation time and optimization potential exists. If some mapping passes have already occurred on G when Specialize is called, two options are available.

Repeating all the mapping steps on G′ can enable more optimization, especially if the behavior of these previous steps is conditioned by the context, but it also likely doubles the compilation time of G. Conversely, starting the mapping process for G′ at the beginning of the step that called Specialize introduces only a fraction of the total mapping time for G′, but may miss some optimization opportunities.

Since each polyhedral pass that uses versioning can split the context of the input GDG in two or more sub-domains, the number of specialized GDGs can grow exponentially with the number of such passes. To limit the risk of an exponential compilation time blowup, the default behavior of Specialize is the latter.

We note that it is not necessary to create a custom-polyhedral statement if it is not supported by the polyhedral compiler infrastructure. The families of specialized GDGs can be maintained in other parts of the mapper state.

### 4.2 Generating Versioning Constraints

Each polyhedral pass whose behavior is determined by parameters, e.g., the size of iteration domains along certain dimensions, or the way array access references relate to each other, is a candidate for versioning. We illustrate polyhedral versioning on the placement pass, because its behavior varies strongly as a function of the iteration domain sizes. Because it is a fairly unsophisticated pass, our discussion can remain centered on versioning itself. Versioning as described herein can also be employed in other passes of polyhedral compilation.

The goal of placement is to define, for each polyhedral statement, a function from its iterations (e.g., any point of its iteration domain) to processor coordinates. The R-Stream machine model represents processing entities in a multi-dimensional hyper-rectangular grid. Hence, placement functions typically have as many dimensions as the targeted processor grid that may include several processors. Let Pl be the placement function of statement op. For any value of the parameters N∈ [symbol] ^{p}, iteration I∈ [symbol] ⁿ of op gets executed by processor x=Pl(I, N).

With the OpenMP target (as one nonlimiting example), the default placement heuristic in R-Stream enumerates the loop dimensions of the polyhedral statements and tries to select the outermost loop dimension. A major test that determines the behavior of placement is checking whether a placement function would occupy the whole processor grid. We call this the occupation test. The test holds when the loop dimension considered for placement to a given processor grid dimension is large enough, e.g., when its trip count is at least the size of the targeted processor grid dimension. When this test fails, the pass declines to distribute the loop across the targeted processor grid dimension and tries the next inner eligible loop, by default.

Unfortunately, when a loop's trip count depends upon GDG parameters and when the context does not bound these parameters, the occupation test is undecidable. Before versioning was introduced, our placement pass made the unchecked assumption that the parameters are large enough for the occupation test to be true. With versioning. we can make this assumption explicit, by creating a version where the assumption is not met.

Because the trip count of a loop often varies as a function of outer loop dimensions, occupation tests can be defined and used alternatively. For instance, we could decide that the average trip count must occupy the grid dimension, or weighted averages among the statements sharing the loop, or the maximum, etc. While several of these tests are available from the placement pass, we chose to use the maximum in some cases. The maximum trip count may be obtained by computing parametric bounding box of the loop's trip count domain and taking the difference (plus one) between the upper and lower bound of the bounding box.

Another parameter of the placement pass is its “occupancy,” which defines the number of loop iterations per processor (along a given processor grid dimension). In other words, occupancy defines a multiplication factor of the targeted grid size to be used by the occupation test.

If c is the occupancy, placement will generally decline to distribute a loop if its trip count is less than c times the targeted processor grid size. The user might set the occupancy to ½ to use only half the processors. On the other hand, the user may require at least 2 iterations of the given loop per processing element by setting the occupancy to 2. When placement selects a loop for placement along dimension k of the processing grid, and its trip count is a parametric function t(N), we let placement trigger the mapping of a specialized GDG by calling Specialize on the current GDG in the placement pass and the following affine constraint:

t(N)≤c·pg(k)

where pg(k) is the size of the processor grid along dimension k. This constraint informs the mapper that t(N) is not large enough when mapping the specialized GDG.

### 4.3 Versioned Code Generation

This section focuses on modifications made to the lowering phase of a polyhedral compiler to generate code for a specializer GDG and in particular its SpecializeOp.

Consider a specializer GDG D with SpecializeOp s. Let n(s) denote the size of the family of specialized GDGs contained in s. Let {Gᵢ}_{∈[n(s)]} denote the family of specialized GDGs in s and let {Cᵢ}_{∈[n(s)]} be the contexts where Ci is the context of Gᵢ with #(Cᵢ) many constraints. A dedicated GDG will correspond to a function in the lowered program that checks for a specialized GDG's context whose constraints are satisfied by the run-time argument values and calls that function lowered for that specialized GDG.

While there might multiple specialized GDGs G and G′ whose contexts the run-time values satisfy, for simplicity, we only enforce that if G′ is (transitively) a specialization of G, G′ is selected. We note that this design choice does not affect correctness. Allowing overlapping contexts prevents us from computing non-convex, complex contexts, which would result in an explosion of conditionals. Instead, we enforce that only one GDG of a given family is executed for any valid value of the original GDG's parameters using if/else constructs. Here is one approach to generate code for D:

```
if (C₁) {
  call the function lowered for G₁
}
else if (C₂) {
  call the function lowered for G₂
}
.
.
.
else if (Cₙ) {
  call the function lowered for Gₙ
}
```

With this code, referred to as a wrapper function, there is the possibility of re-evaluating the same constraint more than once across different if-statements when the contexts share constraints. Furthermore, when Gᵢ is called, all contexts Cⱼ for j≤i need to be checked, which can create a significant overhead.

In some embodiments, we provide a heuristic that generates code for a specializer GDG, and which does not check any constraint more than once for a given set of run-time values, but might check some extra constraints, relative to the constraints of the context of the GDG that the run-time values satisfy. We now proceed to provide details of this heuristic, which may be included in the wrapper function during its generation (also called derivation), where these heuristic would be run after mapping and in the beginning of the lowering phase.

### 4.3.1 Specialization Tree

Our code generation heuristic involves constructing a specialization tree for each SpecializeOp, which mirrors the structure of a conditionally branched code. We use this rooted-tree directly to generate the code for a single specializer GDG. We define two types of nodes in the specialization tree, namely Cnd and FnCall. We let each Cnd node maintain a set of constraints over the GDG parameters to be lowered into checking a condition over the function arguments and each FnCall node maintain a reference to a specialized GDG, whose corresponding function is to be called.

The leaves of the tree will be of type FnCall and all other nodes will be of type Cnd. Each Cnd node will have between one and two children. If a Cnd has one child, then the child corresponds to the true branch of the conditional. Otherwise, if a Cnd node has two children, there will be a distinguished left and right child, which will correspond to the true and false branches of the conditional, respectively. Both types of nodes maintain a Boolean flag indicating whether it is in a true (nested if) or false branch (same-level else).

### 4.3.2 Tree Generation

In this phase where the tree is first generated, each of the Cnd nodes of the tree will have only one constraint. We require the following pre-conditions to hold for the SpecializeOp s prior to tree generation:

No two contexts of specialized GDGs in s are equal.

No specialized GDG in s has an empty context.

To ensure the first condition, for every pair of GDGs that have the same context, we remove one of them from s. To ensure the second condition, we remove GDGs with empty contexts from s. After the pre-conditions are ensured to hold and prior to tree generation, we also assert that the family of specialized GDGs has at least two specialized GDGs. These steps form our pre-processing. Due to the first condition, each GDG uniquely corresponds to a context.

We now define a recursive procedure Tree-Gen to generate the tree. Tree-Gen takes in four arguments: activeCtxs, availCstrs, isTrue and ptNode.

activeCtxs is a set of contexts (and thereby their corresponding GDGs) that are left to be captured by FnCall nodes. availCstrs is a set of constraints that remain available for use by Cnd nodes; here we treat two constraints as equal if and only if they include the same integer points. isTrue is a Boolean flag that indicates whether the current node being constructed is directly within a true or false branch. Lastly, ptNode is the Cnd node that will be the parent of the current node being constructed. The procedure returns the root node of the specialization tree, which is of type Cnd. In the first call to Tree-Gen (after pre-processing), we set the argument values as follows:
activeCtxs: union of the specialized GDG contexts
availCstrs: union of all specialized GDG context constraints
isTrue: true in our convention, but does not matter for root
ptNode: null

On a high-level, the Tree-Gen proceeds as follows:
When activeCtxs. size>1, pick a differentiating constraint c from availCstrs that differentiates two contexts C₁ and C₂ in activeCtxs; in other words, c includes either C₁ or C₂ and does not include the other. Such a c must exist when activeCtxs. size>1 (proved in Lemma 4.1).
When activeCtxs. size=1, pick any c from availCstrs that includes a context in activeCtxs. If no such c exists, then bind the specialized GDG corresponding to the one remaining context in activeCtxs to a FnCall node and return the node. Otherwise, proceed with the next steps.

Create a Cnd node and add c to the node's set of constraints.

Partition activeCtxs into those included (true branch) and not included (false branch) by c. Recursively call Tree-Gen on both of these partitions to build the rest of the specialization tree. We remove c from availCstrs before these sub-calls as it will not be used in the false branch sub-call and should not be chosen again in the true branch sub-call. We add back c after the sub-calls, as it can be used in other parts of the specialization tree. Return the Cnd node created in this call.

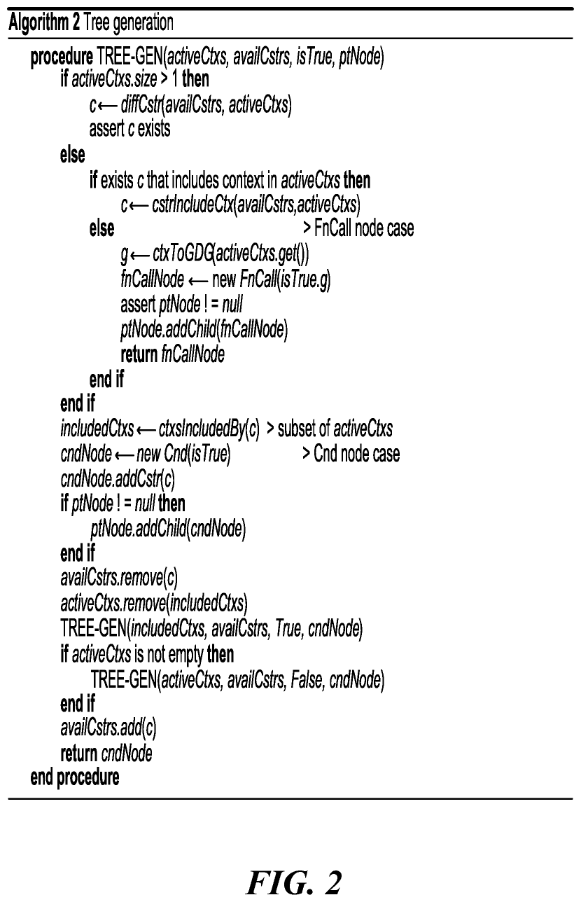

We provide representative pseudocode for the specialization tree generation in Algorithm 2 in FIG. 2.

Lemma 4.1. If activeCtxs. size>1, there exists a constraint in availCstrs that differentiates between two contexts in activeCtxs.

Proof. Suppose activeCtxs. size>1, but none of the constraints in availCstrs differentiates between two contexts in activeCtxs. Consider two contexts C₁ and C₂ in activeCtxs, which must be distinct by the pre-processing. There must be a differentiating constraint c that includes either C₁ or C₂ and does not include the other. c must have been removed in a previous call for which the current call is (transitively) a sub-call of, for otherwise c would be in availCstrs. This implies that c was added to the set of constraints of the Cnd node created in this previous call. However, if this were the case, C₁ and C₂ would not appear in the same activeCtxs, a contradiction.

Lemma 4.1 shows that the claim made in the first high-level step is well-defined. We now show Lemma 4.2, which implies that for each FnCall node, the corresponding GDG context is equivalent to the intersection of the conditions on the path from the root to the node.

Lemma 4.2. Given a FnCall node x, for each constraint c of the corresponding GDG context C, there will exist an ancestor Cnd node a that contains c in its set of constraints. Furthermore, if a has a Cnd child node w that is an ancestor of x, then isTrue must be set for w.

Proof. Suppose that for a FnCall node x, there is some constraint c of the corresponding GDG context C such that no Cnd node ancestor of x contains c in its set of constraints. Now consider the call to Tree-Gen that generates x. c would be in the availCstrs of this call. However, creating a FnCall node only occurs when there are no constraints in availCstrs that cover the one remaining context in activeCtxs, a contradiction. This implies the existence of a Cnd node ancestor a that contains c. Furthermore, if a has a Cnd child node w that is an ancestor of x, the includedCtxs of the call that generates a would contain C and w would be generated in the first sub-call, that is with the isTrue argument set to True.

In Lemma 4.3, we show that for any FnCall node that corresponds to calling the function for a specialized GDG, we do not need to check too many constraints in addition to the constraints of the GDG's context to get to the corresponding function call.

Lemma 4.3. Let s be a SpecializeOp with family of specialized GDGs {Gᵢ}_{∈[n(s)]} and contexts {Cᵢ}_{∈[n(s)]} where Cᵢ is the context for Gᵢ. In the specialization tree for s, the path length from the root to the FnCall node that is associated to Gᵢ is ≤n(s)+#(Cᵢ).

Proof. When activeCtxs. size>1, a call partitions activeCtxs into two sets of size at most activeCtxs. size−1. In this way, ≤n(s) calls are required to get Cᵢ to be the only remaining context in activeCtxs. Then we need to generate ≤#(Cᵢ) many Cnd nodes for the remaining constraints of Cᵢ.

Lemma 4.3 also implies that the depth of a specialization tree for s is ≤n(s)+max_{i∈[n(s)]}#(Cᵢ). When calling the lowered function for Gᵢ, the conditions when our heuristic is guaranteed to beat the simple approach (as far as checking fewer constraints) is given by the following inequality:

n(s)+#(Cᵢ)≤Σⱼ₌₁ⁱ #(Cⱼ)

⇒n(s)≤Σⱼ₌₁ⁱ⁻¹#(Cⱼ)

We sum over all i∈[n(s)] to arrive at the following inequality:

n(s)²≤Σᵢ₌₁^{n(s)}Σⱼ₌₁ⁱ⁻¹#(Cⱼ)·(n(S)−i)

When this inequality holds, we use the heuristic over the simple approach. Furthermore, to make the heuristic better, in the first high-level step, we pick the constraint that results in a partition of activeCtxs into sets that are as close to being equal in size as possible. Ideally, if we are able to select a constraint that exactly partitions activeCtxs into equal sized sets in every call to Tree-Gen, then the n(s) in the upper bound becomes log₂(n(s)), which justifies this additional optimization.

### Tree Collapsing

To render the output code more readable and compact, nested if statements (without same-level else statements) may be collapsed into one if statement that uses a conjunction of the conditionals. While several related simplifications or collapses could be applied, it is not clear that they would actually improve readability. We are not expecting to improve performance here, since the backend compiler will presumably generate equivalent control-flow graphs (CFGs) regardless of whether these extra transformations are performed.

### 4.4 Process Summary

The technique described above can facilitate tradeoffs between parallelization, data-locality, and/or data-layout transformation by versioning source code at compile time. Different versions of the originally specified program or source code are generated. When compiled by a conventional compiler that generates executable code from source code, these different source code versions may yield different respective executables. All of these executables would perform the same computations specified in the original program or source code. The different executables would be optimized differently, however, in terms of parallelization, data locality, and/or data layouts. As such the run-time performance of a computing system executing these different executables can be different.

The run-time performance may include one or more of the following performance metrics: overall processing time, the number of processor cycles, the required memory footprint, data exchange between a main memory and one or more cache levels and/or between different levels of cache, data exchange between the respective local memories of different processors, utilization of the available processors, and/or power and/or energy consumption of the computing system. At runtime, the values of the parameters based on which the versioning is performed would be known. Therefore, only the version that maximizes the performance according to one or more specified performance metrics may be executed, which can optimize the performance of the computing system.

### 5. Polyhedral Versioning Based on Non-Linear Domains

### 5.1 Motivation

Modern compilers are able to leverage optimization opportunities arising under specific run-time conditions by performing compile-time code transformations. This compiler effort is known as versioning or specializing. In this setting, we want to specialize the mapping of GDGs to non-linear domains over its global parameters. Usually, a GDG comes with a linear domain, called its context, which polyhedral mappers use to make mapping decisions. However, the sub-domains of the context introduced by specialization can introduce non-linear constraints into the context. This can occur, for instance, when the specialized domain defines the values of the parameters for which the footprint of the code fits in a particular memory or cache.

There are several ways this issue could be handled. The polyhedral mapper could be modified to handle non-linear constraints, but doing so would definitely make compilation tractability a harder challenge than it already is. Non-linear constraints can trivially guard the execution of a GDG, without incorporating them to the context. However, this would lead to contradictory decisions in the mapper, as in the following example.

Assume that the non-linear constraints restrict the parameters to small values and that the context is unchanged, that is it does not reflect the non-linear constraints in any way. The state of the program as known to the mapper is given by the polyhedral statements and the context. In this case, there is nothing to prevent the mapper from assuming that one or more parameters are large and make mapping decisions that are vastly inconsistent with the non-linear constraints.

Hence, we propose to generate linear constraints that approximate non-linear constraints in a GDG context to avoid inconsistent mapping decisions while maintaining the polyhedral as the base representation. In the next section, we define what constitutes a suitable approximation.

### 5.1 Polyhedral Smoothing

In this section, we define the kind of polyhedral approximation of interest. We express all inequalities in homogeneous form, in which an extra dimension is made to correspond to the scalar factor. Let X∈ [symbol] ⁿ and S(X)≥0 be a system of constraints consisting of m affine inequalities given by C·X≥0 (e.g., our context) and one non-affine inequality f(X)≥0 where · denotes matrix multiplication.

Let [symbol] be the set of solutions to S(X)≥0, and let [symbol] be a domain containing a subset of [symbol] ; we refer to [symbol] as a “bounding domain” for [symbol] . Let [symbol] be an affine approximation defined by a set of affine inequalities P·X≥0; we also refer to [symbol] as a polyhedral domain. Now we define a quantity called superposition that represents how similar [symbol] and [symbol] are relative to the points in [symbol] that are included/excluded by both sets. The best affine approximation is the one that maximizes superposition with the non-affine domain [symbol] , relative to [symbol] .

Definition 5.1 The amount of superposition of a polyhedral domain [symbol] and domain [symbol] over [symbol] is defined as:

$${sup}_{ℬ} ( 𝒫 , 𝒮 ) = {\int }_{X ∈ ℬ} δ ( S ( X ) ) \cdot δ ( P ( X ) ) \qquad ( 5.1 )$$

$$where : δ ( Y ) = \{ \begin{matrix}1 & if & ∀ {Y}_{i} , {Y}_{i} \geq 0 \\ - 1 & if & ∃ i , {Y}_{i} < 0\end{matrix}$$

Here, sup [symbol] ( [symbol] , [symbol] ) increases as the number of points of [symbol] that are either in both [symbol] and [symbol] or outside of both [symbol] and [symbol] grows, and decreases as the number of points of [symbol] that are in one of [symbol] and [symbol] but not the other grows. We refer to the maximization of sup [symbol] ( [symbol] , [symbol] ) as polyhedral smoothing.

Definition 5.2 A polyhedral [symbol] -smoothing [symbol] of [symbol] over [symbol] is a potentially sub-optimal polyhedral smoothing of [symbol] defined by m+ [symbol] inequalities.

Definition 5.3 An optimal polyhedral [symbol] -smoothing [symbol] ₒₚₜ of [symbol] over [symbol] is a polyhedron [symbol] defined by m+ [symbol] inequalities, which maximizes sup [symbol] ( [symbol] , [symbol] ).

$${𝒫}_{opt} ( 𝒮 , ℬ ) = arg {max}_{𝒫} ( {sup}_{B} ( 𝒫 , 𝒮 ) ) \qquad ( 5.2 )$$

Since the m affine constraints of the context are already affine, they can be immediately included in [symbol] . Hence, the core of the problem is to find [symbol] additional affine constraints that optimize superposition with [symbol] , relative to [symbol] . We note here that finding a smoothing is a kind of classification problem, where we are trying to classify a set of points into two classes using a polyhedron, namely the points in [symbol] and the points outside of [symbol] .

### 5.3 Practical Considerations

### 5.3.1 Bounding Domain in the Polyhedral Model of Loops

When [symbol] is unbounded, the integral defined in Equation (5.1) may not converge. To avoid this problem, we only consider a bounded [symbol] in this discussion. Also, a common assumption in the polyhedral model of loops is that the GDG parameters take on integer values, which translates to [symbol] lying on [symbol] ⁿ.

### 5.3.2 Tractability

The context of a GDG is a set of constraints on the parameters, which add to the constraints of the iteration domain of each polyhedral statement of the GDG. Since the tractability of polyhedral mapping depends upon the number of constraints in said iteration domains, the ability to bound the number of new constraints (to [symbol] ) is a factor in the overall tractability of the mapping process.

Additionally, we care about the tractability of computing a polyhedral smoothing itself and are willing to trade optimality of a smoothing for speed of computing it. We solve the problem of finding a good smoothing of [symbol] in two main phases:

Compute a bounding domain [symbol] for

[symbol]

Compute a polyhedral [symbol] -smoothing P for [symbol] over

[symbol]

The next section details these steps: first, we compute a polyhedral (implicitly, [symbol] -polyhedral) bounding domain [symbol] using a combination of convex hull and inflation (e.g., outward facet shifting, as in) to include points that are outside but near the edge of [symbol] . Then, we introduce “cuts” formed from the constraints of [symbol] (a polyhedron) that maximize a discrete version of the superposition function su [symbol] for computational efficiency and well-definedness. We now elaborate on these phases in the subsequent sections.

### 5.4 Algorithm

### 5.4.1 Phase I

For both mathematical and computational simplicity, it is preferable that [symbol] has both a simple structure and convenient representation. Hence, we consider [symbol] with the form of a polyhedron. We define a procedure for constructing [symbol] . Assuming (efficient) access to points in [symbol] via queries to an SMT solver, the general idea is to

Sample “boundary” points of [symbol] and take the convex closure of these points to arrive at a polyhedron.

Sample additional “boundary” points of [symbol] and apply outward facet shifting to polyhedron (from step 1) to include these points and arrive at

[symbol]

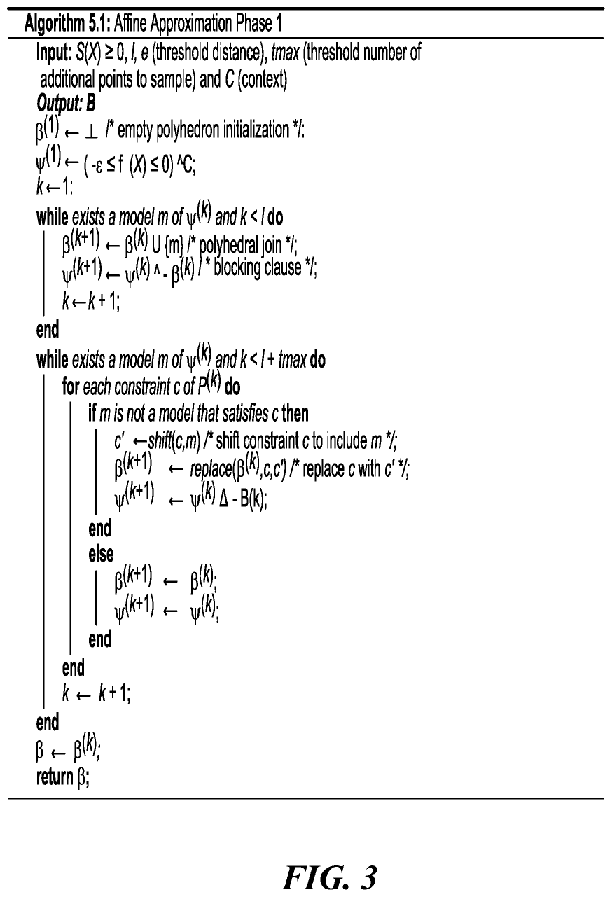

The first step generates a polyhedron that, in principle, should involve a low number of constraints. Then the second step modifies this polyhedron to include more points while maintaining the same number of constraints. We note that this approach will yield [symbol] , a polyhedron that is bounded, regardless of whether [symbol] is bounded or not. To define the boundary points, we consider the following. Let ϵ≥0 and consider the family of sets [symbol] _{ϵ}={X∈ [symbol] ⁿ|f(X)≥−ϵE}. By definition, [symbol] = [symbol] ₀, and [symbol] _{ϵ}⊆ [symbol] _{ϵ}, where 0≤ϵ≤ϵ′. Here, upon fixing €, we can realize [symbol] ϵ\ [symbol] as the set of boundary points. The pseudocode for the first phase is shown in FIG. 3.

The function shift can be defined as follows. Given an affine constraint:

a·X≤b

where a is a scalar vector and b is a scalar and a point v outside the corresponding affine half-space, the following affine constraint represents a possible shifted affine constraint that includes v and all solutions to the non-shifted constraint:

a·X≤b+(a·v−b)

Thus, the algorithm terminates since all steps terminate and there are a finite number of iterations in each of the loops.

### 5.4.2 An LP-Based Alternating Method

The goal of this phase is to compute the polyhedral [symbol] -smoothing of [symbol] over [symbol] , which was computed in the first phase. We begin this section with some preliminary definitions and notions:

Let [symbol] ⁺ be a concatenation of integral points (as columns) in [symbol] ∩ [symbol] .

Let [symbol] ⁻ be a concatenation of integral points (as columns) in [symbol] \ [symbol] , but negated.

Let [symbol] =( [symbol] ⁺| [symbol] ⁻) be the column-wise concatenation of [symbol] ⁺ and [symbol] ⁻ in matrix form.

Given a matrix M, let Mᵢ: be the i^{th} row and M_{:j} be the j^{th} column.

Given polyhedron [symbol] and a fixed enumeration of constraints of [symbol] , let P^{(-q)} refer to the polyhedron with the q^{th} constraint removed.

Given P·X≥0 is the matrix form of polyhedron [symbol] , P^{(-q)} refers to the matrix obtained by removing the q^{th} row, and p^{(-q)}. X≥0 is the corresponding system of constraints.

Let inside (p^{(-q)}) refer to the set of column indices of [symbol] that correspond to points of [symbol] that are also in [symbol] ^{(-q)} .

Since [symbol] (as constructed in the first phase) is a convex closure of finitely many integer points, [symbol] is a finite matrix.

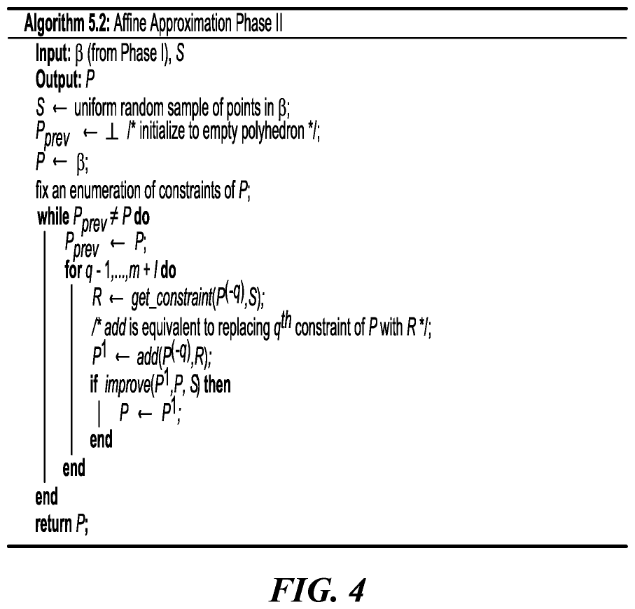

Our method proceeds to compute an [symbol] -smoothing [symbol] by starting with the polyhedron B and iteratively replacing each of the constraints until no further improvement can result from the replacements. More formally, the approach may be given by the pseudo-code show in in FIG. 4.

Here, add adds the input constraint to the set of constraints defining the input polyhedron to form a new polyhedron. get_constraint generates a constraint by optimizing an LP system. The LP system formulation captures the following intuition:

Generate a half-space (e.g., a homogeneous constraint ax≥0) that contains p^{(-q)}. In other words, the constraints of [symbol] imply the constraint of the half-space.

In an effort to maximize superposition, shift ax≥0 by γ to obtain and return a new constraint a′x≥0. Here, γ≤0 is suitably chosen.

Regarding the first piece of intuition, we use the affine form of Farkas' lemma. In particular, we have

ax=λP^{(-q)}x+β, λ∈ [symbol] ≥0, β≥0 (5.3)

We now elaborate on the second piece of intuition. If the shift γ is negative, then the resulting half-space will be cutting through the polyhedron P^{(-q)}. Now, maximizing superposition is equivalent to maximizing the number of points in [symbol] that are “on the good side” of our constraints. More formally, consider the constraint modified from Equation (5.3) with slack variable ϵⱼ for each column j (e.g., a sample point) of [symbol] :

a.S_{:j}+γ=λP^{(-q)}S_{:j}+β+γ+ϵⱼ≥0, λ∈ [symbol] ≥0, β, ϵⱼ≥0, γ≤0 (5.4)

Intuitively, ϵⱼ provides some leeway for each sample to deviate from the constraints and maximizing superposition corresponds to maximizing the objective function given by the number of constraints with ϵⱼ equal to zero. However, since this objective function is not linear, we minimize the following substitute objective function as a heuristic for maximizing superposition:

min Σⱼϵⱼ (5.5)

To avoid creating constraints that are equivalent up to a scaling factor, we also restrict our focus to convex combinations:

β+γ+ [symbol] λₖ=1 (5.6)

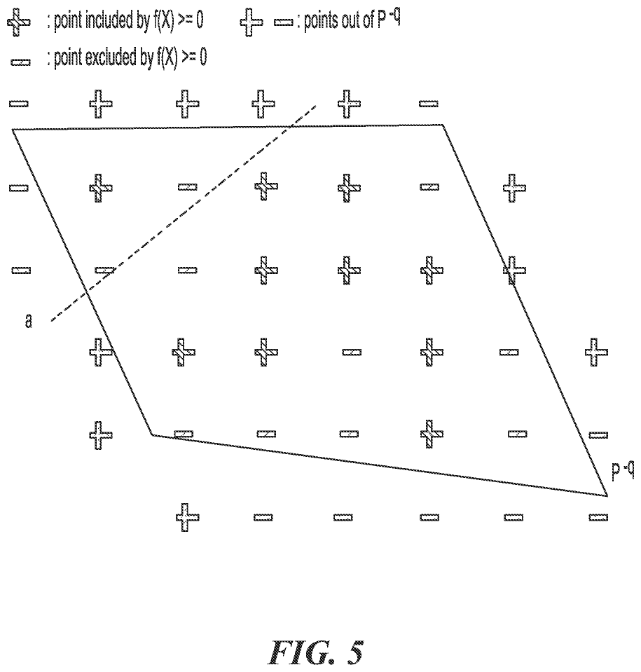

Furthermore, only the points of [symbol] that are already in [symbol] ^{(-q)} can influence the objective function. Indeed, as illustrated in FIG. 5, adding constraint a′ cannot further exclude points that were already excluded by [symbol] ^{(-q)} (the lighter shade points in FIG. 5), and it cannot include these points either. Then in Equation (5.4) we can restrict j to values in inside(P^{(-q)}) to reduce the number of constraints in the LP system. Hence, our LP system is as follows:

$$\{ \begin{matrix}min {\sum }_{j ∈ i n s i d e ( {P}^{- q} )} {ϵ}_{j} \\ λ {P}^{( - q )} {S}_{: j} + β + γ + {ϵ}_{j} \geq 0 , ∀ j ∈ inside ( {P}^{( - q )} ) \\ {λ}_{k} \geq 0 , ∀ k ∈ [ m + ℓ - 1 ] \\ γ \leq 0 \\ β \geq 0 \\ {ϵ}_{j} \geq 0 , ∀ j ∈ inside ( {P}^{( - q )} ) \\ β + γ + {\sum }_{k ∈ [ m + ℓ - 1 ]} {λ}_{k} = 1\end{matrix} \qquad ( 5.7 )$$

improve checks if the constraint generated by get_constraint is not already in P and if P′ represents a strict improvement in the superposition. If these two conditions hold, then P′ is chosen over P; otherwise, P is maintained.

### 5.4.2.1 Performance-Precision Trade-Off

Again here, since the number of points in [symbol] (within [symbol] ⁿ, that is), even just in P^{-q}, can be impractically large, we substitute for [symbol] a uniformly sampled subset of its integer points. The direct effect of such a sampling is a (often dramatic) decrease in the number of columns of [symbol] .

### 5.4.2.2 Complexity Analysis

The LP system has one linear objective function to minimize and the following number of linear constraints:

|inside(P^{(-q)}|+m+ [symbol] −1+1+1+|inside(P^{(-q)}|+1

=2·|inside (P^{(-q)}|+m+ [symbol] +2

We now prove the algorithm terminates, by showing a time complexity bound. Let d be the number of samples. With each iteration of the outer loop, the superposition (over the uniformly sampled subset) must increase by at least one due to the termination condition. This implies, in the worst case, the outer loop must make at most 2|d|+1 many iterations. Letting cost(LP) denote the cost of solving an LP, we have the following time complexity bound for this phase:

[symbol]

(d(m+ [symbol] )cost(LP))

5.4.2.3 Guaranteeing [symbol] Constraints

It is possible that the optimal value of A found with Equation (5.7) will produce a redundant cut (in which case we have β=0). The resulting polyhedron will then have less than [symbol] constraints. This is fine as we only want to limit the number of constraints of the resulting smoothing to m+ [symbol] . However, there may be an opportunity to reintroduce extra constraints after more constraints have evolved. To do so, we simply try to find one more optimal cut after a given optimal cut is found, until we cannot find one or we have reached m+ [symbol] constraints.

### 5.4.2.4 Weighed Search

Using a substitute objective function based on a distance between the constraints of [symbol] and the points of [symbol] make that the original goal of maximizing the points correctly included or excluded becomes a goal of minimizing the sum of distances between the new constraint a and the misclassified (sampled) points of [symbol] ^{-q}. A pathological case of this substitute goal is when a constraint is chosen that includes one previously misclassified point f that is far from the original constraint, to the expense of excluding several points that were close from the original constraint. In that particular case, the number of misclassified points goes up, and hence superposition goes down, while our substitute superposition objective goes up.

Such bias can be mitigated by trying to direct the search to including regions that include a lot of points of [symbol] and to exclude regions that exclude a lot of points excluded by [symbol] . This is done by defining a weight w for each point. This corresponds to the following change of variable:

ϵᵢⱼ=Wⱼϵ′ᵢⱼ (5.8)

where j is the index of the considered point in [symbol] . Points in desirable regions get a higher weight. Injecting Equation (5.8) in the objective function can steer the search toward optimizing the classification of the high-weighted points.

One way to determine weight is to evaluate how many points in the same class are found in the neighborhood of considered point x (e.g., a hypercubic box H(x) centered on x of a given width):

$$w ( x ) = \frac{\# ( H ( x ) ⋂ S )}{\# H ( x )} \qquad ( 5.9 )$$

for points contained in [symbol] and

$$w ( x ) = \frac{\# ( H ( x ) ∖ S )}{\# H ( x )} \qquad ( 5.1 )$$

for points not contained in [symbol] , where \ represents the set difference operator.

### 5.5 Polyhedral Smoothing as a Neural Net Learning Problem

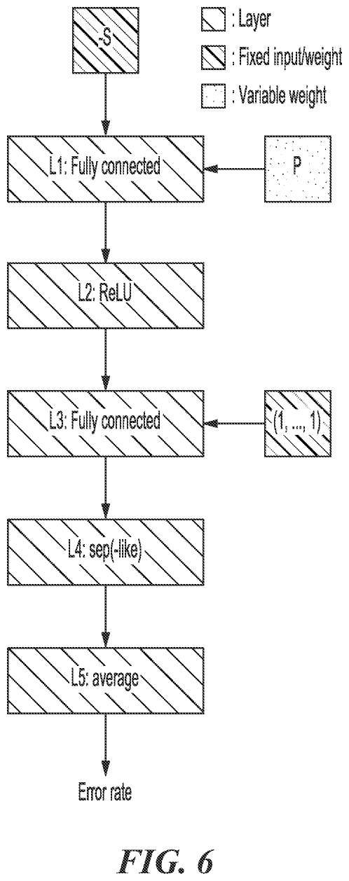

The exact objective function for an [symbol] -smoothing of [symbol] used in Section 4.2 is the number of non-negative entries of (P.S). This objective can be expressed with a fairly simple neural network, represented in FIG. 6. P. S is a matrix multiplication, which is modeled as a fully-connected (FC) layer L₁. We use −S as the set of input samples, and P is the weight matrix for this FC layer.

The output is a matrix of integer numbers that is positive whenever a sample point is misclassified. By putting this matrix through a rectified linear unit (ReLU) activation function (let us call it L₂), we keep the misclassified points (per constraint) into a matrix of the same shape as (P.S). Another layer, L₃ takes this matrix of misclassified points per constraint and sums the elements of its columns. The result is a vector that has one element per sampled point.

An element of the vector is positive if and only if a point is misclassified by any constraint of P. L₃ can for instance be implemented with a constant-weight matrix of one row and as many columns as the number of constraints in P, and whose elements are all 1. The outputs of L3 are thresholded to 1 using a step-like activation L₄. Since both P and S have integer coefficients, the entries of the output vector to L₄ are either a 0 or a 1. The error function can then be defined as the ratio of misclassified points, e.g., average value of the elements of the output to L₄. We can use any deep learning framework to train this model based on the above error function, and obtain an optimal polyhedral smoothing. The variable of this training is P, which are the coefficients of the constraints of the smoothing [symbol] .

### 5.6 Generalization

### 5.6.1 Systems of Non-Affine Inequalities

The algorithms presented above for polyhedral smoothing can be applied to systems with more than one non-affine inequality, for instance by incorporating (and smoothing) one non-affine inequality at a time. One interesting question that rises in this case is, given a budget of l affine constraints to smooth a set of j non-affine inequalities, how many constraints we should allow for each smoothing operation. One way to define such distribution is to interpolate each non-affine inequality with a polynomial. Since it can be expected that higher-degree polynomials will have more inflection points, the number of constraints (k) allowed for each smoothing should be an increasing function of the degree of the interpolated polynomial.

### 5.6.2 Arbitrary Function and Number of Versions

The same smoothing algorithm, as well as its subsequent versioning can be adapted to handle the case of an arbitrary function within a bounded context. A slightly more general way to perform versioning would be as follows:
Define n versions of a GDG.
Define a function pf that maps each point of the context to one of the n preferred versions.
for each version k∈[1, n]:

Use a polyhedral smoothing, such as Algorithm??, to determine the polyhedral specialization context for version k within each of the specialization contexts for versions [1, k−1].

Function pf can be computed in one of the following ways:
running the versions and collecting their run time or a combination of their run time and other properties of the versions (e.g., code size, power consumption).
evaluating an algorithm that estimates these properties, by associating a scalar value to a given (GDG version, numerical parameters) pair.

There is a degree of freedom in the order in which the versions are considered in the partitioning algorithm. Partitioning can be done across two subsets of the versions at a time. For instance, we can first generate a specialization context that partitions versions [1, m] from version [m+1, n], where m∈[2, n−1]. Then, we can find a specialization context that partitions the version sets further into two non-empty sets, and so on until all the version sets considered contain only one version. This leads to a decomposition algorithm with log₂(n) partitions.

We describe techniques for implementing versioning in a polyhedral compiler, where different source-code versions of a code segment containing a loop or a loop nest can be generated and compiled at compile time. The version that is most efficient according to a selected criterion or criteria (e.g., parallelization, memory locality, cache performance (e.g., due to a data-layout transformation), execution time, etc.) would be selected and executed at runtime.

In contrast to polyhedral optimization just-in-time (PolyJIT) discussed above, in our approach the number of polyhedral compilations is not dependent upon the number of dynamic instances of a GDG's parameters.

We have presented some heuristics to reduce the overall number of conditionals being tested in the nested conditional code that defines which version is to be executed. Our work differs from the techniques that may handle nested conditionals in the genera context in that we have the advantage of knowing that all our conditionals are affine relationships and that conjunctions thereof form a polyhedral context. This allows us to drive code generation based on loose and tight inclusion relationships. Also, since we are generating these conditionals from a partition of a polyhedral context, rather than using trace or profile-based techniques, it can be more effective to compute the importance of each context at compile-time, either by using polyhedral counting methods or through polyhedral sampling of the context.

We describe the trade-offs made to avoid paying for improved run-time performance with an explosion of versions and a subsequently long compilation time.

Embodiments of the overall technique described herein successfully demonstrates the usefulness of compile-time versioning in the polyhedral model. Various embodiments are presented in the context of the placement pass of polyhedral compilation, but the specialization described herein can be incorporated in various other polyhedral passes, as well.

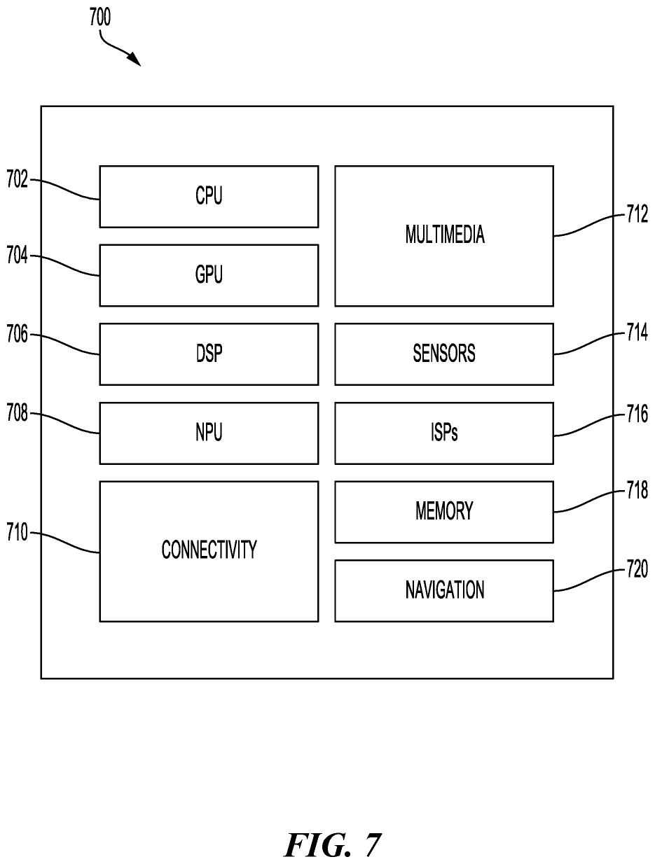

FIG. 7 is a block diagram illustrating an example implementation of a host system-on-a-chip (SoC) 700, including a dead iteration eliminator, in accordance with certain aspects of the present disclosure. The host SoC 700 includes processing blocks tailored to specific functions, such as a connectivity block 710. The connectivity block 710 may include fifth generation (5G) connectivity, fourth generation long term evolution (4G LTE) connectivity, WI-FI connectivity, universal serial bus (USB) connectivity, Bluetooth® connectivity, Secure Digital (SD) connectivity, and the like.

In this configuration, the host SoC 700 includes various processing units that support multi-threaded operations. For the configuration shown in FIG. 7, the host SoC 700 includes a multi-core central processing unit (CPU) 702, a graphics processor unit (GPU) 704, a digital signal processor (DSP) 706, and a neural processor unit (NPU) 708. The host SoC 700 may also include a sensor processor 714, image signal processors (ISPs) 716, a navigation module 720, which may include a global positioning system (GPS), and a memory 718. The multi-core CPU 702, the GPU 704, the DSP 706, the NPU 708, and a multimedia engine 712 support various functions such as video, audio, graphics, gaming, artificial networks, and the like. Each processor core of the multi-core CPU 702 may be a reduced instruction set computing (RISC) machine, an advanced RISC machine (ARM), a microprocessor, or some other type of processor. The NPU 708 may be based on an ARM instruction set.

According to aspects of the present disclosure, a host device includes means for receiving, means for generating, means for identifying, means for generating, means for building, means for propagating, means for determining, and means for outputting. In one configuration, each of these means may be the CPU 702, GPU 704, DSP 706, NPU 708 or ISP 716, as shown in FIG. 7. In other aspects, the aforementioned means may be any structure or any material configured to perform the functions recited by the aforementioned means.

As noted above, dead code elimination (DCE) is a compiler technique for increasing program performance and reducing the executable size by removing program parts that do not contribute to the program output. Conventional DCE implementations identify instructions not producing live-out data and remove these program parts entirely. However, it may happen that only some dynamic executions of the instructions are dead. This situation notably arises when an instruction is enclosed inside a loop, and some iterations of that loop do not contribute to the program output. For example, with graph compilers, excess computation may be introduced by operator sequences, such as when some output of a given operator is not used. Iteration domains of basic operators may be reduced due to specialization, sparsification, and/or subsampling. For general compilers, parameters may remove some computation or output while corresponding computations (partly) remain. Moreover, bugs may be present in the code.

Code removal has applications to optimization and productivity. For computational graph compilers, code removal enables automatic removal of excess computation not contributing to the final output, reducing the need for custom operators. Code removal also enables automatic specialization, sparsification, and/or subsampling of sequences of operators, including custom operators. For general compilers, dead code elimination may be complemented with dead iteration elimination. The techniques extend static analysis ability to detect potential bugs, for example, out of bound memory accesses.

Some definitions for the following description are now provided. Statement iterations are a subset of the executions of a statement enclosed within an iterative loop. Contributing statement iterations are those iterations written to a memory location that is part of the output. Computation output is a live-out data space of a computational kernel or a function as analyzed by a compiler, or, output data space, for example, output tile, sparsified, or subsampled output as specified by the user. An application domain that is an ideal application domain is known as static control codes. Loop bounds and conditionals are affine expressions of outer loop counters and constant parameters. Tensor access functions are affine expressions of outer loop counters and constant parameters. Ideal code for removing dead iterations would remove all dead iterations. Even without the ideal code, the techniques of the present disclosure are still valuable even though some dead iterations may remain. The dead iteration removal techniques may have applications with artificial intelligence or deep learning operators (e.g., matrix multiplication, softmax, or convolution operations) or scientific computation kernels (e.g., a Jacobi solver or Sobel filter).

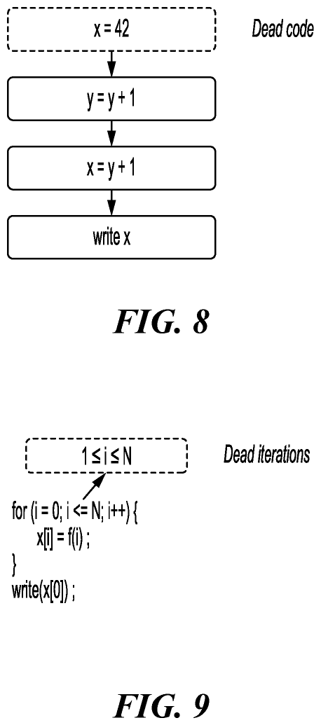

FIG. 8 is a diagram illustrating dead code removal. As seen in FIG. 8, the line of code x=42 is not used to obtain the result of the overall code segment because x is later set to y+1. Accordingly, the dead line of code x=42 may be removed.

FIG. 9 is a diagram illustrating dead iteration removal, in accordance with various aspects of the present disclosure. In the example of FIG. 9, the output of the loop only relies on the value x[0]. Thus, the iterations of i having a value between 1 and N require computations that do not contribute to the final output. Accordingly, the dead iterations 1≤i≤N can be identified and removed without affecting the final result of the loop. Dead iteration removal has applications with graph compilers compiling applications built from standard blocks, operator composition, and inactivation of iterations due to for example, specialization, sparsification, and/or subsampling.

Aspects of the present disclosure introduce dead iteration elimination (DIE) to identify and remove iterations of a loop that do not contribute to program output. Dead iteration elimination relies on polyhedral analysis to compute the required data space and the contributing iterations. Dead iteration elimination enables the safe removal of parts of the iteration space, possibly up to complete statement removal, in a complementary way to dead code elimination. Dead iteration elimination also considers required output specifications, opening new applications such as automatic specialization, sparsification, and/or subsampling.

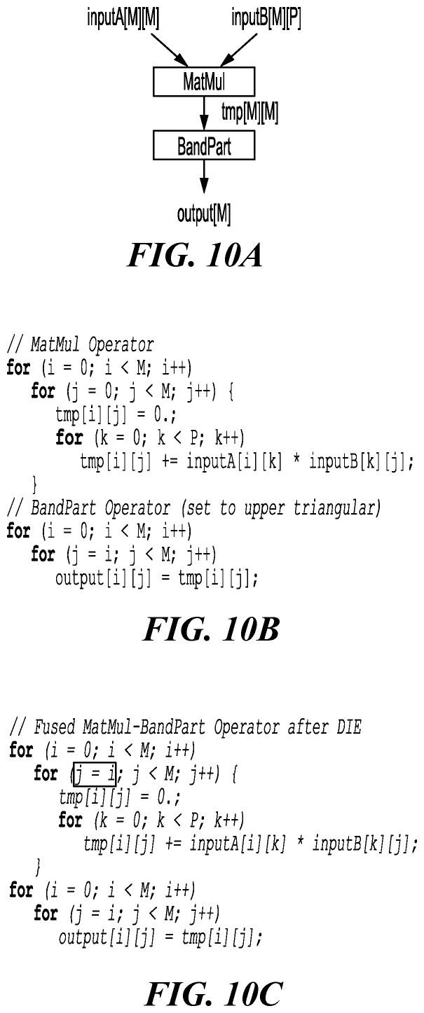

There exists a number of situations where only a subset of the dynamic executions of an instruction actually contributes to a program output. In such cases, dead code elimination techniques fail at removing them because the techniques address only complete instruction removal. The problem may be particularly prominent when applications are built from a limited set of pre-defined high-level operators, such as in artificial intelligence and deep learning frameworks. In this context, the output of some operators may not be used entirely by subsequent operators. An illustration is shown in FIG. 10A.

FIG. 10A is a block diagram illustrating a high level subgraph, in accordance with various aspects of the present disclosure. As shown in FIG. 10A. the composition of MatMul and BandPart TensorFlow-like operators filter only upper triangular elements of a matrix-multiplication output. The compound operator code built from the concatenation of each operator code is shown in FIG. 10B.

FIG. 10B is a diagram illustrating fused operator code corresponding to the composition of operators shown in FIG. 10A, in accordance with various aspects of the present disclosure. The code shown in FIG. 10B features many “dead iterations.” e.g., loop iterations not contributing to the program output.

Aspects of the present disclosure present a polyhedral compilation approach called dead iteration elimination (DIE) to remove the dead iterations and generate code, for example, as seen in FIG. 10C. FIG. 10C illustrates fused operator code after dead iteration elimination. In this example, the temporary tensor (tmp) may be removed as well, using specific analysis outside the scope of this document.

Dead iteration elimination enables a number of advances, including achieving finer-grain optimization with regards to dead code elimination by acting at the loop iteration level rather than at the full statement level. Consequently, the composition of artificial intelligence/deep learning (AI/DL) operators with auto-removal of non-pertinent computation is possible, reducing the need for specialized custom operators. Dead iteration elimination may apply full statement removal in dead iteration space situations that could not be identified by dead code elimination, in a complementary way. Dead iteration elimination enables new applications when a specification of the output data space exists, for example, specialization, sparsification and/or subsampling of AI/DL operators, which inactivate parts of their original computation space. Dead iteration elimination provides static analysis information exposing potential programming mistakes during software development, for example, ill-formed loops or out-of-bound accesses.

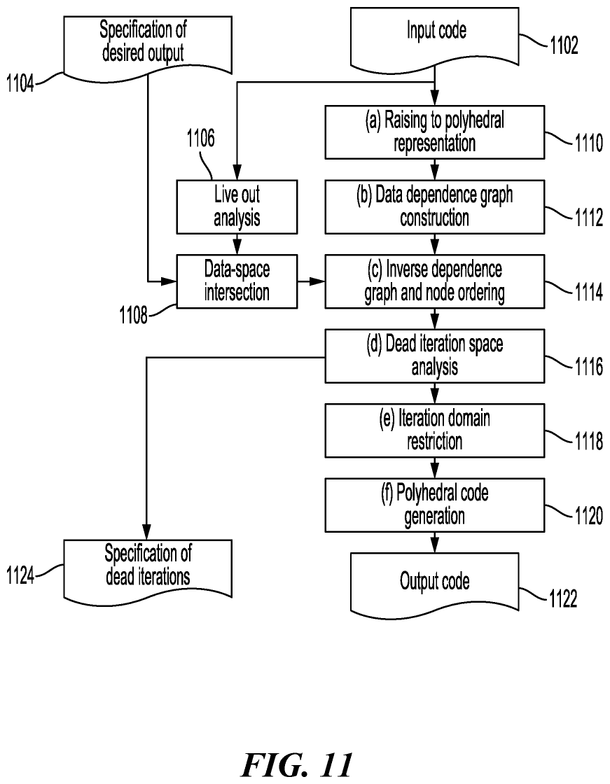

Dead iteration analysis and removal are now discussed in more detail. FIG. 11 is a flow diagram illustrating dead iteration elimination, in accordance with various aspects of the present disclosure. The dead iteration elimination process takes as input program code (block 1102) as well as an optional specification of the desired output data (block 1104), e.g., which parts of the data space the code should actually compute. This specification can be used to specialize the code, for example, to compute only a given data tile and/or to inject regular sparsity or subsampling information, such as to compute only half the data according to a checkerboard layout. The specification is combined with an automatic live-out analysis (block 1106) to form the required data space (block 1108). Iterations not contributing directly or indirectly to a write to the required data space are dead.

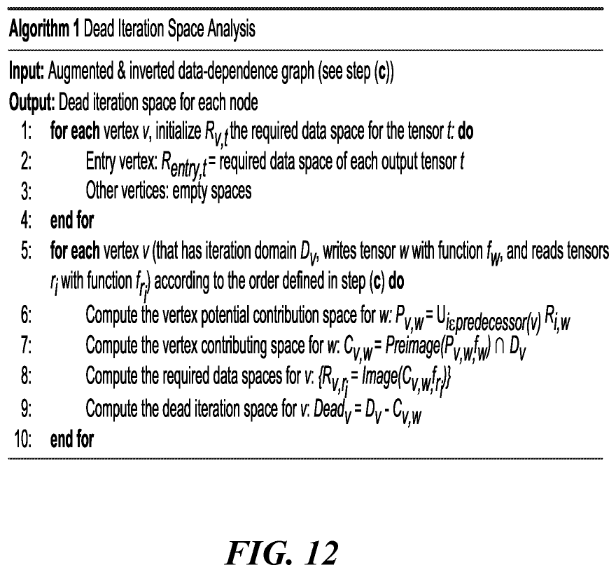

According to aspects of the present disclosure, dead iteration elimination follows a six-step process to generate both an output code cleared from dead iterations and a specification of the dead iteration space for further analysis, for example, to generate compiler warnings. The principle of dead iteration elimination is to back-propagate constraints on the required data spaces along the data dependence graph where cycles involving more than one node are removed, from nodes producing the output data to nodes reading the input data. Those constraints on data translate to constraints on the iteration space, restricted to remove dead iterations. The consecutive steps are as follows:
(a) (block 1110) Raising to polyhedral representation achieves extraction of a polyhedral representation, including iteration domains, data access functions, and scheduling of the original program as offered by polyhedral compilers.
(b) (block 1112) Data dependence graph construction builds the data dependence graph (DDG) and its strongly connected component graph, enabling a convenient node ordering during the next step. Each strongly connected component corresponds to a compound statement writing or reading all data references written or read in the original nodes. In the following, they are considered as single nodes.
(c) (block 1114) Inverse dependence graph and node ordering finds a convenient node traversal ordering for backward propagation of constraints. First, block 1114 builds an inverse dependence graph by (1) inverting all edges of the graph computed in the previous step, (2) adding an “entry” node with edges from that node to all nodes writing to a required output, and (3) adding an “exit” node with edges from all nodes reading input data to that node. Finally, block 1114 computes a topological order for that graph, not taking into account self-dependencies.
(d) (block 1116) Dead iteration space analysis is the core of the process. FIG. 12 illustrates pseudocode for a dead iteration space analysis process, in accordance with various aspects of the present disclosure. Without loss of generality and for clarity reasons, suppose each node writes only one tensor, as it can easily be generalized. Starting from the required data space specified for each output tensor, the process walks back the DDG up to the statements reading the input data, and uses polyhedral operations such as image or preimage by the access functions to move from data space to iteration space, and conversely. For each node, first compute the potential contribution space, e.g., the parts of the required data space to which that node may contribute. Then, compute the contributing space, e.g., the parts of the iteration space actually contributing. Next, compute the required data space, e.g., the parts of the data space that the node requires. Finally, compute the dead iteration space as the difference between the iteration domain and the contributing space. The specification of dead iterations (shown in FIG. 11, block 1124) enables programmer feedback, e.g., compiler warnings.
(e) (block 1118) Iteration domain restriction replaces each statement iteration domain with the difference between that iteration domain and the dead iteration space for that statement.
(f) (block 1120) Polyhedral code generation finally produces the output code (block 1122) without dead iterations from the modified representation, using polyhedral code generation techniques. Polyhedral code generation is exploited on restricted iteration domains.

Techniques of the present disclosure introduce an approach to dead iteration elimination, leveraging polyhedral analysis to generate code where loop iterations not contributing to the output are removed. The techniques support desired output data specification enabling a number of applications, including code specialization, sparsification, and/or subsampling.

Example applications for dead iteration elimination include tile-specialized code generation. Given a set of output tiles and a general code, the goal is to generate the code, computing only the given set of output tiles. For example, with an image processing filter, a general mean filter may be specialized to a given tile. Original code may be reduced to improved code, which is specialized to a desired tile output (e.g., [64 . . . 127][67 . . . 127] by employing dead iteration elimination (DIE).

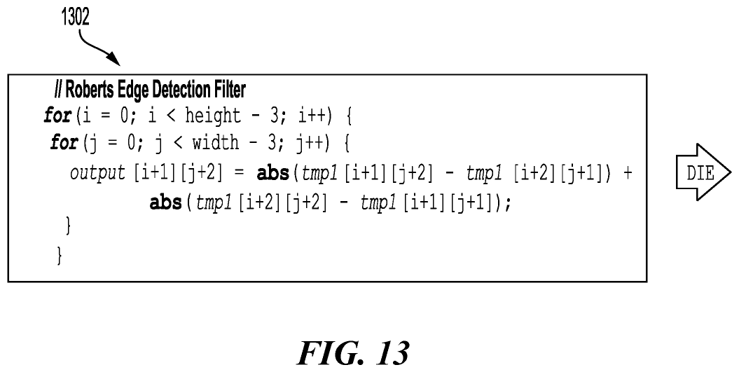

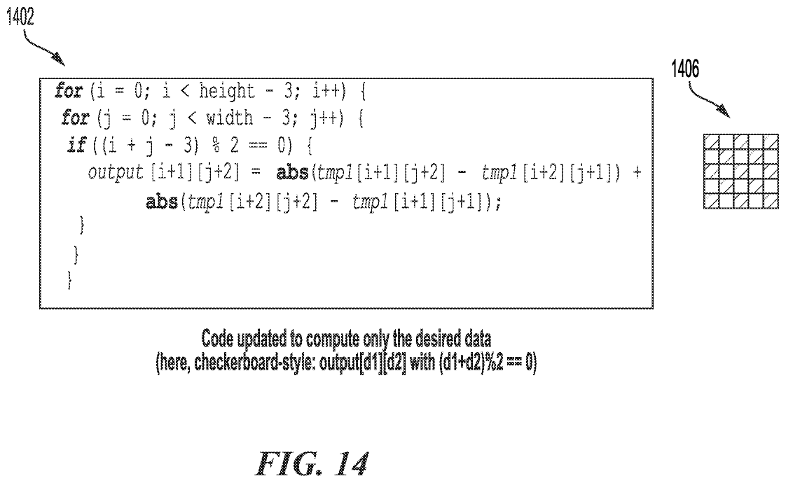

FIGS. 13 and 14 illustrate an example of sparsification/subsampling, in accordance with various aspects of the present disclosure. Given a dense operator and structured sparsity information, dead iteration elimination may generate the code, producing only the desired data. In the example of FIGS. 13 and 14, original code 1302 is reduced to improved code 1402, which is limited to checkerboard subsampling by employing dead iteration elimination (DIE). The code is updated to compute only a checkerboard output 1406, which corresponds to output[d1][d2] with (d1+d2)%2==0.

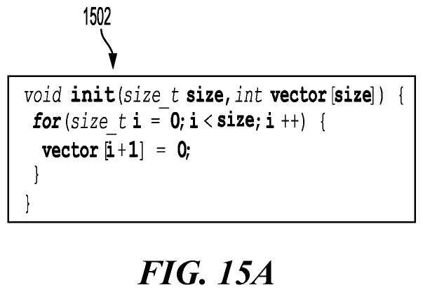

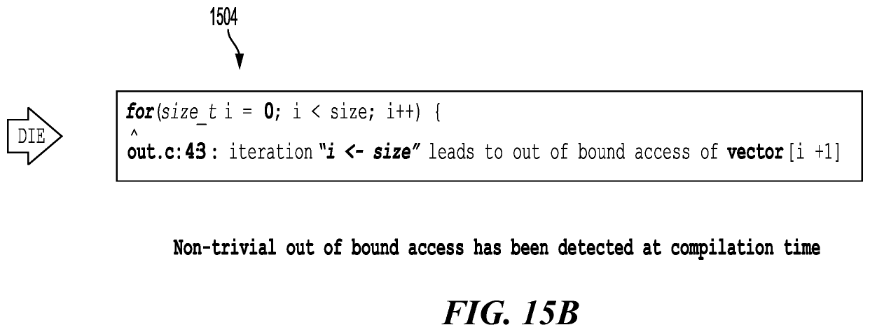

FIGS. 15A and 15B illustrate examples of a compiler warning, in accordance with various aspects of the present disclosure. In the examples of FIGS. 15A and 15B, a compiler warns the user that some iterations are missing or not contributing to the data space. In the example of FIGS. 15A and 15B, original code 1502 is reduced to improved code 1504 by employing dead iteration elimination (DIE) for detection of non-trivial out of bounds access at compilation time. The out of bounds access is not detected by current state of the art static checkers.

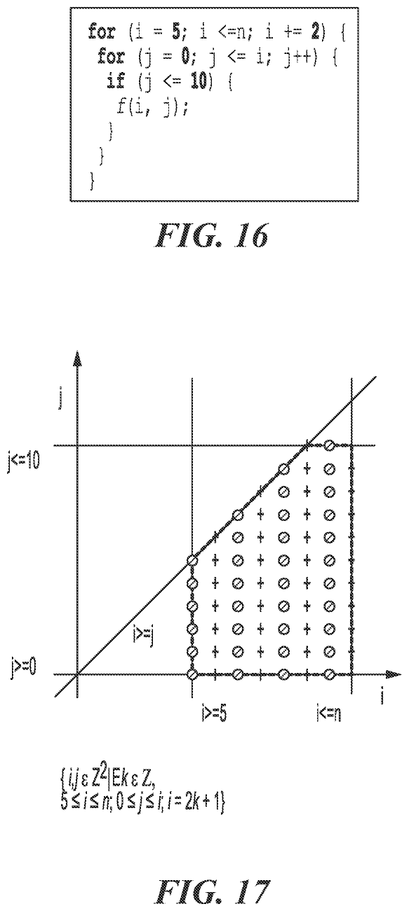

FIG. 16 illustrates code for a polyhedral model application, in accordance with various aspects of the present disclosure. FIG. 17 illustrates a polyhedral representation corresponding to the code illustrated in FIG. 16, in accordance with various aspects of the present disclosure. Polyhedral models may correspond to the execution of loop nests in a vector space. Loop iterations and data accesses are integer-valued points within a polyhedron. Techniques exist for many alayses and tasks, with the support of high level math libraries. For instance, dead iteration elimination relies on fusion, intersection, projection, image, and preimage of polyhedral libraries. Code or a compiler intermediate representation (IR) can be generated from the polyhedral representation. Many neural network layers can be efficiently modeled using the polyhedral model. Moreover, the technology has a broader application domain, including radar, image and signal processing, physics simulations, etc.

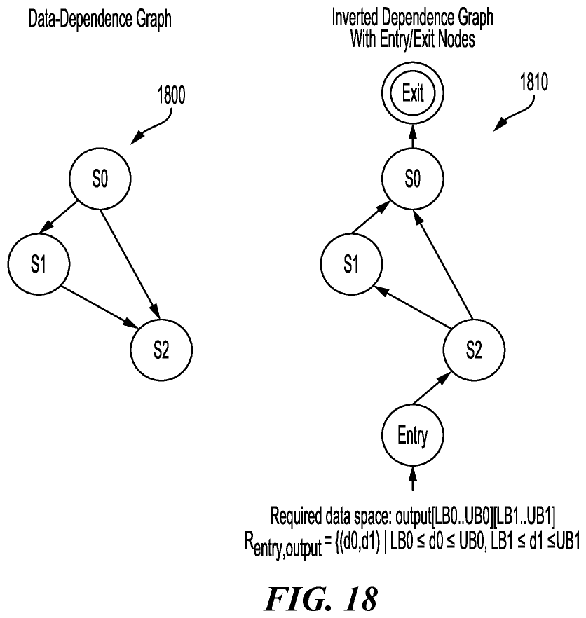

FIG. 18 illustrates a data dependence graph and an inverted data dependence graph, in accordance with various aspects of the present disclosure. Dead iteration space analysis is now described with reference to the dependence graphs illustrated in FIG. 18. The principle is to back-propagate data shape constraints through operations on these shapes and update iteration domains accordingly. First, the process builds an inverted data dependence graph (e.g., inverted edges) 1810 from an original data dependence graph 1800, each including states S0, S1, and S2. The inverted data dependence graph 1810 includes a new entry vertex with edges to every vertex writing the output tensors. The required data space in this example includes an output with a first lower bound (LB0), to a first upper bound (LB0) and also a second lower bound (LB1) to a second upper bound (UB1). The R_{entry.output} is thus {(d0,d1)|LBo≤d0≤UB0, LB1d1≤UB1} where d1 and d0 are parameters, and R_{entry.output} represents the required data space at the entry node for the output array. The inverted data dependence graph 1810 also includes a new exit vertex with edges from every vertex reading the input tensors, and nodes involved within a dependence cycle merged into a supernode.

For each vertex v in the inverted data dependence graph, the process initializes R_{v,t} (e.g., the required data space for the tensor t in each entry vertex): R_{entry,t}=required data space of each output tensor t. Other vertices are initialized with empty spaces.

For each vertex v, according to a topological ordering of the nodes (where v has iteration domain Dᵥ, writes tensor w with function f_{w}, and reads tensors rᵢ with function fᵣᵢ), the following steps occur.

Vertex potential contribution space for the written tensor w: P_{v,w}=U_{i in predecessor(v)} R_{i,w,} where U is the polyhedral union operation.

Vertex contributed space for the written tensor w: C_{v,w}=Preimage(P_{v,w}, f_{w}) [symbol] Dᵥ, where [symbol] is the polyhedral intersection operation.

Required data spaces for v: {R_{v,ri}=Image(C_{v,w}, fᵣᵢ)}

Dead iteration space for v: Deadᵥ=Dᵥ−C_{v,w}

For each vertex v, the process restricts the iteration domain using the polyhedral difference: Dᵥ=Dᵥ−Deadᵥ

Aspects of the present disclosure enable dead code elimination reasoning and processing at the iteration level rather than at the full statement or full loop level. Various aspects enable automatic iteration level removal of excess computation that does not contribute to the final output. Aspects enable automatic specialization, sparsification, and/or subsampling of, or sequences of, operators, including custom operators. Further aspects extend the static analysis ability to detect potential bugs, such as out of bound memory accesses. Other aspects provide analyses and removal techniques to identify and eliminate non-useful statement iterations from a program. The input may be a computational kernel or function code. The output may be the identification of non-useful statement iterations and/or a semantically equivalent code cleared from those iterations.

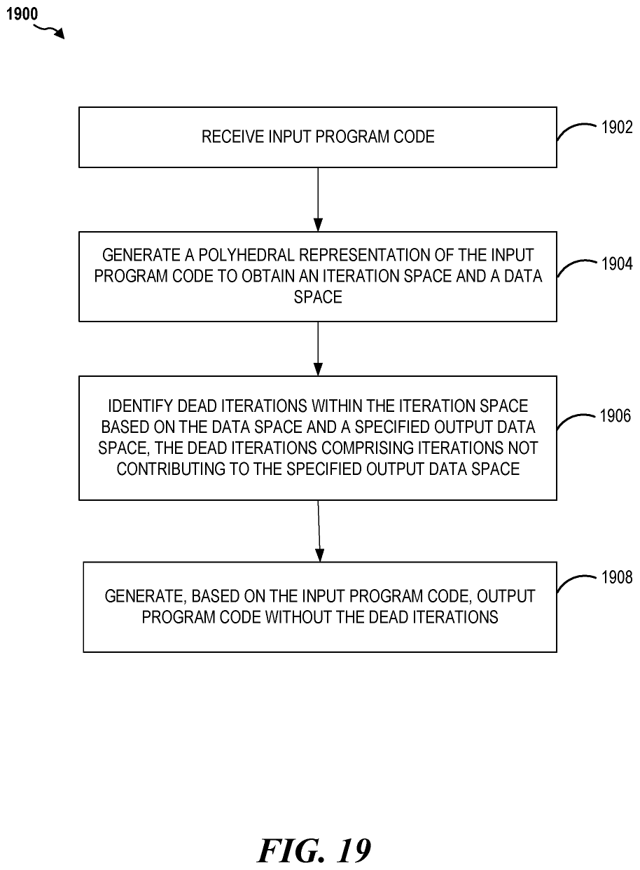

FIG. 19 illustrates a method for dead iteration removal, in accordance with aspects of the present disclosure. As shown in FIG. 19, in some aspects, the process 1900 may receive input program code (block 1902). The process 1900 may optionally receive a specification of a desired output data space. In some aspects, the process 1900 may generate a polyhedral representation of the input program code to obtain an iteration space and a data space (block 1904).

In some aspects, the process 1900 may identify dead iterations within the iteration space based on the data space and a specified output data space. The dead iterations comprise iterations not contributing to the specified output data space (block 1906). The process 1900 may identify the dead iterations by building an inverted data dependence graph, and propagating constraints on the data space along the inverted data dependence graph through operations on the data space and the iteration space to update the iteration space. The process 1900 may determine a difference between an iteration space for each vertex of the inverted data dependence graph and a contributing space for each vertex of the inverted data dependence graph.

In some aspects, the process 1900 may generate, based on the input program code, output program code without the dead iterations (block 1908). The process 1900 may also output a dead iteration space specification.

### EXAMPLE ASPECTS

Aspect 1: An apparatus comprising: at least one memory; and at least one processor coupled to the at least one memory, the at least one processor configured: to receive input program code; to generate a polyhedral representation of the input program code to obtain an iteration space and a data space; to identify dead iterations within the iteration space based on the data space and a specified output data space, the dead iterations comprising iterations not contributing to the specified output data space; and to generate, based on the input program code, output program code without the dead iterations.

Aspect 2: The apparatus of Aspect 1, in which the at least one processor is further configured to build an inverted data dependence graph.

Aspect 3: The apparatus of Aspect 1 or 2, in which the at least one processor is further configured to propagate constraints on the data space along the inverted data dependence graph through operations on the data space and the iteration space to update the iteration space.

Aspect 4: The apparatus of any of the preceding Aspects, in which the at least one processor is further configured to determine a difference between an iteration space for each vertex of the inverted data dependence graph and a contributing space for each vertex of the inverted data dependence graph.

Aspect 5: The apparatus of any of the preceding Aspects, in which the at least one processor is further configured to output a dead iteration space specification.

Aspect 6: The apparatus of any of the preceding Aspects, in which the at least one processor is further configured to receive a specification of a desired output data space, the specified output data space being based on the specification of the desired output data space and a live-out analysis.

Aspect 7: A processor-implemented method, comprising: receiving input program code; generating a polyhedral representation of the input program code to obtain an iteration space and a data space; identifying dead iterations within the iteration space based on the data space and a specified output data space, the dead iterations comprising iterations not contributing to the specified output data space; and generating, based on the input program code, output program code without the dead iterations.

Aspect 8: The method of Aspect 7, in which identifying the dead iterations comprises building an inverted data dependence graph.

Aspect 9: The method of Aspect 7 or 8, in which identifying the dead iterations further comprises propagating constraints on the data space along the inverted data dependence graph through operations on the data space and the iteration space to update the iteration space.

Aspect 10: The method of any of the Aspects 7-9, in which identifying the dead iterations further comprises determining a difference between an iteration space for each vertex of the inverted data dependence graph and a contributing space for each vertex of the inverted data dependence graph.

Aspect 11: The method of any of the Aspects 7-10, further comprising outputting a dead iteration space specification.

Aspect 12: The method of any of the Aspects 7-11, further comprising receiving a specification of a desired output data space, the specified output data space being based on the specification of the desired output data space and a live-out analysis.

Aspect 13: An apparatus comprising: means for receiving input program code; means for generating a polyhedral representation of the input program code to obtain an iteration space and a data space; means for identifying dead iterations within the iteration space based on the data space and a specified output data space, the dead iterations comprising iterations not contributing to the specified output data space; and means for generating, based on the input program code, output program code without the dead iterations.

Aspect 14: The apparatus of Aspect 13, in which the means for identifying the dead iterations comprises means for building an inverted data dependence graph.

Aspect 15: The apparatus of Aspect 13 or 14, in which the means for identifying the dead iterations further comprises means for propagating constraints on the data space along the inverted data dependence graph through operations on the data space and the iteration space to update the iteration space.

Aspect 16: The apparatus of any of the Aspects 13-15, in which the means for identifying the dead iterations further comprises means for determining a difference between an iteration space for each vertex of the inverted data dependence graph and a contributing space for each vertex of the inverted data dependence graph.

Aspect 17: The apparatus of any of the Aspects 13-16, further comprising means for outputting a dead iteration space specification.

Aspect 18: The apparatus of any of the Aspects 13-17, further comprising means for receiving a specification of a desired output data space, the specified output data space being based on the specification of the desired output data space and a live-out analysis.

Aspect 19: A non-transitory computer-readable medium having program code recorded thereon, the program code executed by a processor and comprising: program code to receive input program code; program code to generate a polyhedral representation of the input program code to obtain an iteration space and a data space; program code to identify dead iterations within the iteration space based on the data space and a specified output data space, the dead iterations comprising iterations not contributing to the specified output data space; and program code to generate, based on the input program code, output program code without the dead iterations.

Aspect 20: The non-transitory computer-readable medium of Aspect 19, in which the program code to identify the dead iterations comprises program code to build an inverted data dependence graph.

Aspect 21: The non-transitory computer-readable medium of Aspect 19 or 20, in which the program code to identify the dead iterations further comprises program code to propagate constraints on the data space along the inverted data dependence graph through operations on the data space and the iteration space to update the iteration space.

Aspect 22: The non-transitory computer-readable medium of any of the Aspects 19-21, in which the program code to identify the dead iterations further comprises program code to determine a difference between an iteration space for each vertex of the inverted data dependence graph and a contributing space for each vertex of the inverted data dependence graph.

Aspect 23: The non-transitory computer-readable medium of any of the Aspects 19-22, in which the program code further comprises program code to output a dead iteration space specification.

Aspect 24: The non-transitory computer-readable medium of any of the Aspects 19-23, in which the program code further comprises program code to receive a specification of a desired output data space, the specified output data space being based on the specification of the desired output data space and a live-out analysis.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. Sets and subsets, in general, include one or more members.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some embodiments, a client-server model as needed. Accordingly, the methods, devices, and systems can utilize multiple processors and/or processor devices, and the processor/ processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus comprising:
at least one memory; and
at least one processor coupled to the at least one memory, the at least one processor configured:
to receive input program code;
to generate a polyhedral representation of the input program code to obtain an iteration space and a data space;
to identify dead iterations within the iteration space based on the data space and a specified output data space, the dead iterations comprising iterations not contributing to the specified output data space; and
to generate, based on the input program code, output program code without the dead iterations.

2. The apparatus of claim 1, in which the at least one processor is further configured to build an inverted data dependence graph.

3. The apparatus of claim 2, in which the at least one processor is further configured to propagate constraints on the data space along the inverted data dependence graph through operations on the data space and the iteration space to update the iteration space.

4. The apparatus of claim 3, in which the at least one processor is further configured to determine a difference between an iteration space for each vertex of the inverted data dependence graph and a contributing space for each vertex of the inverted data dependence graph.

5. The apparatus of claim 1, in which the at least one processor is further configured to output a dead iteration space specification.

6. The apparatus of claim 1, in which the at least one processor is further configured to receive a specification of a desired output data space, the specified output data space being based on the specification of the desired output data space and a live-out analysis.

7. A processor-implemented method, comprising:
receiving input program code;
generating a polyhedral representation of the input program code to obtain an iteration space and a data space;
identifying dead iterations within the iteration space based on the data space and a specified output data space, the dead iterations comprising iterations not contributing to the specified output data space; and
generating, based on the input program code, output program code without the dead iterations.

8. The method of claim 7, in which identifying the dead iterations comprises building an inverted data dependence graph.

9. The method of claim 8, in which identifying the dead iterations further comprises propagating constraints on the data space along the inverted data dependence graph through operations on the data space and the iteration space to update the iteration space.

10. The method of claim 9, in which identifying the dead iterations further comprises determining a difference between an iteration space for each vertex of the inverted data dependence graph and a contributing space for each vertex of the inverted data dependence graph.

11. The method of claim 7, further comprising outputting a dead iteration space specification.

12. The method of claim 7, further comprising receiving a specification of a desired output data space, the specified output data space being based on the specification of the desired output data space and a live-out analysis.

13. An apparatus comprising:
means for receiving input program code;
means for generating a polyhedral representation of the input program code to obtain an iteration space and a data space;
means for identifying dead iterations within the iteration space based on the data space and a specified output data space, the dead iterations comprising iterations not contributing to the specified output data space; and
means for generating, based on the input program code, output program code without the dead iterations.

14. The apparatus of claim 13, in which the means for identifying the dead iterations comprises means for building an inverted data dependence graph.

15. The apparatus of claim 14, in which the means for identifying the dead iterations further comprises means for propagating constraints on the data space along the inverted data dependence graph through operations on the data space and the iteration space to update the iteration space.

16. The apparatus of claim 15, in which the means for identifying the dead iterations further comprises means for determining a difference between an iteration space for each vertex of the inverted data dependence graph and a contributing space for each vertex of the inverted data dependence graph.

17. The apparatus of claim 13, further comprising means for outputting a dead iteration space specification.

18. The apparatus of claim 13, further comprising means for receiving a specification of a desired output data space, the specified output data space being based on the specification of the desired output data space and a live-out analysis.

19. A non-transitory computer-readable medium having program code recorded thereon, the program code executed by a processor and comprising:
program code to receive input program code;
program code to generate a polyhedral representation of the input program code to obtain an iteration space and a data space;
program code to identify dead iterations within the iteration space based on the data space and a specified output data space, the dead iterations comprising iterations not contributing to the specified output data space; and
program code to generate, based on the input program code, output program code without the dead iterations.

20. The non-transitory computer-readable medium of claim 19, in which the program code to identify the dead iterations comprises program code to build an inverted data dependence graph.

21. The non-transitory computer-readable medium of claim 20, in which the program code to identify the dead iterations further comprises program code to propagate constraints on the data space along the inverted data dependence graph through operations on the data space and the iteration space to update the iteration space.

22. The non-transitory computer-readable medium of claim 21, in which the program code to identify the dead iterations further comprises program code to determine a difference between an iteration space for each vertex of the inverted data dependence graph and a contributing space for each vertex of the inverted data dependence graph.

23. The non-transitory computer-readable medium of claim 19, in which the program code further comprises program code to output a dead iteration space specification.

24. The non-transitory computer-readable medium of claim 19, in which the program code further comprises program code to receive a specification of a desired output data space, the specified output data space being based on the specification of the desired output data space and a live-out analysis.
